(19) United States
(12) Patent Application Publication
(10) Pub. No.: US 2005/0181150 A1
(43) Pub. Date: Aug. 18, 2005

(54) Image-forming method and image-receiving material and method for producing same material

(75) Inventor: Toshiaki Aono, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/058,250

(22) Filed: Feb. 16, 2005

(30) Foreign Application Priority Data
Feb. 16, 2004 (JP) 2004-038354
Feb. 16, 2004 (JP) 2004-038355

(51) Int. Cl. B41M 5/00

(52) U.S. Cl. 428/32.34

(57) ABSTRACT

The invention provides an image-receiving material comprising a support and a porous layer disposed on or above the support, wherein the image-receiving material satisfies at least one of requirements (1) and (2) defined below. The porous layer comprises particles having a charge and either particulates having a charge opposite to that of the particles or a water-soluble polymer having a charge opposite to that of the particles. (1) The porous layer is the uppermost layer having an average pore diameter of from 0.05 to 100 μm; (2) the particles are organic particles. The invention also provides a method for producing the image-receiving material and an image-forming method using the image-receiving material.

### CROSS-REFERENCE TO RELATED APPLICATIONS

This application claims priority under 35 USC 119 from Japanese Patent Application Nos. 2004-38354 and 2004-38355, the disclosures of which are incorporated by reference herein.

### BACKGROUND OF THE INVENTION

1. Field of Invention

The present invention relates to a method for forming images on an image-receiving material and an image-receiving material for use in the method.

2. Description of the Related Art

Various characteristics are demanded of image-receiving materials for ink jet printing; such as ability to form images with high chroma saturation thereon, ability of dyes to be firmly fixed to the image-receiving materials for ink jet printing, and ability of the materials to dry quickly so as not to cause bleeding of ink. In the way of image-receiving materials for ink jet printing to respond to such demands, materials that are produced by applying a liquid containing inorganic particles and water-soluble resins such as polyvinyl alcohol and gelatin on a support to form a porous layer (an ink-receiving layer) (see Japanese Patent Application Laid-Open No. 10-119423, for example) and the like are conventionally known.

Regarding ink for ink jet printing, various kinds of ink such as water-soluble dye ink, pigment ink, dispersion ink, UV ink, and solvent ink are known. In practical use, water-soluble ink is mainly used, with pigment ink also being used in some applications. Pigment ink is superior in water resistance and light resistance compared to water-soluble dye ink. However, when pigment ink is printed on an image-receiving material intended for ink jet printing having the aforementioned ink-receiving layer, the ink does not penetrate sufficiently into the ink-receiving layer and the resulting images are poor in chafing resistance and glossiness.

As a solution to this problem, a recording method is known in which an aqueous ink containing a pigment (carbon black) having a small primary particle diameter, a low structure, and a specific binder (a macromolecule having an amide bond and/or a urethane bond) is used. In this method, printing is applied to a specific ink jet printing sheet, that is, one in which a porous layer is disposed on a support, the layer having, pores with an average diameter of 1 μm or less and being formed by applying a liquid wherein inorganic particles are dispersed by a binder resin (see claims 1 and 6 of JP-A No. 2002-97390). The reason given for the average pore diameter being up to 1 μm is that if the diameter is greater than that, carbon black dispersion particles in the ink penetrate the porous layer and fail to remain on the recording sheet, leading to insufficient print density.

One of the technical objectives of image recording is the increase of recording speed. Similarly, high speed is also demanded of ink jet printing, especially, high speed printing using a line head.

However, since ink-receiving layers in conventional image-receiving materials used for ink jet printing have relatively small average pore diameters (for example, 0.03 μm in the recording sheet (specially designed glossy film B) as disclosed in Table 7 in paragraph 0085 of JP-A 2002-97390), water-soluble ink, pigment ink, dispersion ink, UV ink, and solvent inks, which have been developed widely for ink jet printing, are not necessarily able to form images with sufficient quality. Specifically, when a dispersion ink for ink jet printing (that is namely, an ink comprising dispersed colored particles obtained by enclosing an oil-soluble dye in oil-soluble polymer particles) is printed to the aforementioned ink jet-use image-receiving material, the dispersion ink displays extremely poor penetration and lacks in quick drying. It is therefore currently impossible to use dispersion ink for high speed printing.

A recording sheet which is adapted to high-speed ink jet printing and prevents ink from blurring or bleeding is proposed in JP-A No. 2000-190630. This recording sheet is composed of inorganic particles and polyolefin resin, and at least 80% of a void capacity thereof is accounted for in pores having a pore diameter of 1 μm or less, in other words, pores having a diameter larger than 1 μm are substantially eliminated from the sheet (see paragraph 0007).

However, the method for producing this recording sheet has many problems since it requires mixing a plasticizer with the inorganic particles and the polyolefin resin, shaping the mixture into sheet form while heat-melting and kneading the mixture, and thereafter removing the plasticizer by extraction using an organic solvent. Further, the porous film produced with the above-mentioned method is highly hydrophobic and therefore is insufficient in terms of absorbability of aqueous ink.

JP-A No. 2000-238408 discloses an image-receiving material used in ink jet printing produced by applying a liquid to form an image-receiving layer containing particles having a positive charge, particles having a negative charge, and an aqueous binder on a support. The liquid is then dried to form an image-receiving layer having a porous structure. The image-receiving layer is superior in strength, has a high porosity, and contains uniform pores. Therefore, it possesses high ink absorbability and is superior in dye fixability.

Ink jet-use the image-receiving material is, however, basically intended for use with water-soluble dye ink.

One possible measure for improving the permeability of dispersion ink is to increase the average pore diameter of the porous layer. However, if the average pore diameter is increased simply by using particles having a large average particle diameter, film strength is reduced. Further, the surface is rough and results in uneven printing. Thus, it is impossible to produce good-quality images, and printed images lack glossiness. Also, if the average pore diameter is large, inks such as dispersion ink penetrate deeply into the image-receiving layer, resulting in lowered image density. Therefore, an image-forming method which can produce images with a high glossiness and high density using any kind of ink jet-purpose ink, including dispersion ink, is not known.

### SUMMARY OF THE INVENTION

The present invention has been devised in light of the above-described circumstances. The invention provides an image-receiving material which allows high-speed printing using a line head even when a dispersion ink is used; an image-forming method by which high gloss high-density images can be formed; and an image-receiving material for use in the image-forming method. In addition, the invention provides an image-receiving material having a porous layer which exhibits high ink permeability when a dispersion ink is used for ink jet printing; a method for the production of the image-receiving material; and an image-forming methods using the image-receiving material.

Namely, the invention provides an image-receiving material comprising a support and a porous layer disposed on or above the support, wherein the image-receiving material satisfies at least one of requirements (1) and (2) defined below, and the porous layer comprises particles having a charge and either particulates having a charge opposite to that of the particles or a water-soluble polymer having a charge opposite to that of the particles: (1) the porous layer is the uppermost layer having an average pore diameter of from 0.05 to 100 μm; (2) the particles are organic particles.

Further, the invention provides a method for producing an image-receiving material comprising applying a coating liquid on or above a support to form a porous layer, wherein the coating liquid comprises organic particles having a charge and either organic particulates having a charge opposite to that of the organic particles or a water-soluble polymer having a charge opposite to that of the organic particles.

Furthermore, the invention provides an image-forming method comprising printing with ink on an image-receiving material.

### BRIEF DESCRIPTION OF THE DRAWINGS

Preferable embodiments of the present invention will be described in detail based on the following figures.

FIG. 1 shows an example of heating rollers for use in a smoothening treatment in the image-forming method of the invention.

FIG. 2 shows an example of pressure rollers and a heating belt for use in a smoothening treatment in the image-forming method of the invention.

### DETAILED DESCRIPTION OF THE INVENTION

The “image-receiving material having a porous layer with an average pore diameter of from 0.05 to 100 μm as its uppermost layer” for use in a first embodiment of the present invention is applicable to various kinds of inks including dispersion ink owing to its great average pore diameter. Dispersion ink is one in which colored particles that enclose therein an oil-soluble dye are dispersed in oil-soluble polymer particles. By printing on the image-receiving material and then smoothening the printed surface, it is possible to produce high-density images with a high gloss.

An image-receiving material which when printed with ink and then smoothened to give a resulting printed surface with a glossiness of 30% or more at a 75° incident angle of specular reflection is preferred as it can produce images with high glossiness.

The image-receiving material for use in a second embodiment of the invention has a porous layer formed through application on a support of either a coating liquid containing organic particles having a charge and organic particulates having a charge that is opposite to that of the organic particles, or a coating liquid containing organic particles having a charge and a water-soluble polymer having a charge opposite to that of the organic particles. The porous layer is useful as an ink-receiving layer in an image-receiving material intended for ink jet printing and also is usable as a cushion layer or a heat insulating layer of transfer materials.

In the image-forming method of the invention, it is desirable to use the above-mentioned ink jet-use image-receiving materials and the above-mentioned ink for ink jet printing.

The “image-receiving material having a porous layer with an average pore diameter of from 0.05 to 100 μm as its uppermost layer” are first explained below.

Image-Receiving Material

Porous Layer

The average pore diameter of the porous layer in the image-receiving material of the present invention is from 0.05 to 100 μm in the first embodiment and from 0.001 to 100 μm in the second embodiment. In both embodiments, it is preferably from 0.1 to 50 μm, more preferably from 0.3 to 30 μm, still more preferably from 0.5 to 30 μm, and most preferably from 1 to 30 μm. The thickness of the porous layer is approximately from 1 to 100 μm, preferably approximately from 5 to 90 μm, and more preferably approximately from 10 to 80 μm.

“Average pore diameter” as used herein is measured with mercury porosimetry proposed by Washburn, described by Kohei Urano, in “Theory, Apparatus and Problems of Pore Size Distribution of Porous Materials 1”, found in “Surface” Vol. 13, No. 10 page 588. A mercury porosimeter (trade name: PORESIZER 9320-PC2, manufactured by Shimadzu Corp.) is used in measuring.

When the porous layer in the material of the invention is formed on a paper support or the like by coating and, therefore, precise measurements with mercury porosimetry are impossible, the average pore diameter is determined as follows. Scanning electron Microscopic photographs of the surface of the image-receiving material are first taken at different magnifications, and the photographs are digitalized with a scanner inputting process. The distribution of diameters of circles whose areas are the same as those of void portions extracted by computer image analysis of the digitalized photographs is converted to obtain an average diameter (number average), that is taken to be the average pore diameter.

The porous layer preferably has thermoplasticity. “Thermoplasticity” as used herein means a property of matter to become softer and deform at a temperature higher than a certain temperature. When thermoplasticity is imparted to a porous layer, a smoothening treatment is easily applied to a printed surface after printing of images, which can greatly improve glossiness.

In order for a porous layer to be thermoplastic, it is desirable that a substance accounting for at least 30% by mass, more preferably at least 50% by mass, still more preferably at least 65% by mass, and most preferably at least 95% by mass of the composition forming the porous layer be thermoplastic. Moreover, a substance of at least 50% by mass, preferably at least 80% by mass of the thermoplastic substance has a glass transition temperature (Tg) of from 25 to 150° C., preferably from 40 to 130° C., and particularly preferably from 50 to 100° C. in the first embodiment and particularly preferably from 50 to 120° C. in the second embodiment.

A Tg lower than 25° C. may result in an insufficient porosity, which may cause a decrease in porosity during storage of image-receiving materials or may cause blocking failure. When the Tg is higher than 150° C., the porous layer is brittle and it is impossible to sufficiently effect a smoothening treatment after printing.

In forming the porous layer of the first embodiment, it is desirable to have the porous layer contain grains in view of easiness of production. For the porous layer containing grains, a porous layer containing grains having a charge and other grains having an opposite charge; or a porous layer containing grains having a charge and a water-soluble polymer having a charge opposite to that of the grains are preferred. This is since crosslinking coagulation readily occurs due to electrostatic bonds between the grains or the grains and the polymer. A method in which two kinds of oppositely charged grains, namely particles and particulates, is preferred for forming the porous layer having a higher porosity.

It is desirable that the oppositely charged two kinds of grains be organic particles and organic particulates. Moreover, it is desirable that the grains used in combination with the water-soluble charged polymer be organic particles.

In order for the porous layer formed in such a manner to have thermoplasticity, it is desirable that at least one kind be thermoplastic, when two kinds of oppositely charged grains are used, and more desirable that both kinds of grains be thermoplastic. When oppositely charged particles and water-soluble polymer are used, it is desirable that the particles be thermoplastic, and further, that the water-soluble polymer be thermoplastic. Even when neither the particles nor the polymer have thermoplasticity, it is possible to impart thermoplasticity to a porous layer by adding to the layer a thermoplastic binder resin having a low glass transition temperature, to be described later.

In the second embodiment, the coating liquid for forming the porous layer in the material of the invention contains organic particles having a charge and organic particulates having a charge opposite to that of the organic particles, or contains organic particles having a charge and a water-soluble polymer having a charge of a sign opposite to that of the charge of the organic particles.

The coating liquid may further optionally contain one or more components as described later. The coating liquid is prepared by dispersing and/or dissolving a component for forming the porous layer in water or a mixed solvent of water and water-soluble solvent. The polymer dispersion mentioned below may be used without change when used as the particle having a charge.

Examples of the water-soluble solvent include alcohols such as methanol, ethanol, n-propanol, i-propanol, and methoxypropanol, and also acetone.

Next, the charged particles/particulates and the charged polymer for use in the invention are explained.

Particles(/Particulates) Having a Positive Charge

As particles/particulates having a positive charge, both organic particles/particulates and inorganic particles/particulates are usable in the first embodiment. In the second embodiment, the particles/particulates having a positive charge are organic particles/particulates. Examples of particles/particulates having a positive charge which are preferably used for the particles/particulates include polymer particles/particulates having on the main chain or side chain thereof a cationic group such as a primary, secondary, or tertiary amino group, an imino group, salts of a primary to tertiary amino group or an imino group (e.g. hydrochlorides), a quaternary ammonium salt group, or a pyridinium salt group, and specifically include polyurethane particles, polyester particles, polyacrylic acid ester particles, polymethacrylic acid ester particles and polystyrene particles having on the main chain or side chain a cationic group such as a primary, secondary, or tertiary amino group, an imino group, salts of a primary to tertiary amino group or an imino group, a quaternary ammonium salt group or a pyridinium salt group.

The content of polymerizable monomer units having a cationic group such as a primary, secondary, or tertiary amino group, an imino group, salts of a primary to tertiary amino group or an imino group, a quaternary ammonium salt group or a pyridinium salt group relative to the polymer constituting the particles is from 0.1 to 100 mol %, preferably from 0.5 to 50 mol %, and particularly preferably from 1 to 30 mol %.

The weight-average molecular weight (Mw) of the polymer is suitably approximately from 3,000 to 100,000, and more preferably approximately from 5,000 to 50,000.

A dispersion of positively charged polymer is usable for the polymer particles/particulates.

As this kind of dispersion, a polymer dispersion having a positive charge can be used, and dispersion of a (co)polymer containing the monomer units disclosed in paragraphs 0018-0032 of JP-A No. 9-114066 may be used. Monomer units a), b) and c), which constitute the (co)polymer, are represented by the following Formula (1).

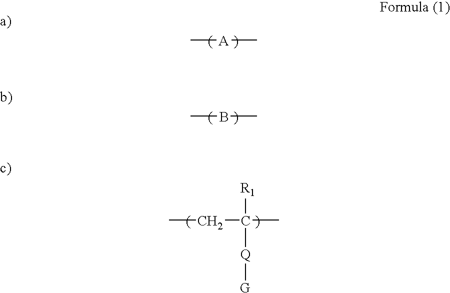

In Formula (1), A in the monomer unit a) denotes a monomer unit which has at least two polymerizable ethylenically-unsaturated groups and in which a copolymerizable monomer is copolymerized so that at least one of the copolymerizable ethylenically-unsaturated groups is contained in a side chain. B of the monomer unit b) denotes a monomer unit in which an ethylenically-unsaturated monomer, which can be further copolymerizable, is copolymerized. In monomer unit c), R₁ denotes a hydrogen atom, a lower alkyl group (having 1-6 carbon atoms), or an aralkyl group (having 7-12 carbon atoms). Q denotes a divalent linking group such as an alkylene group (having 1-12 carbon atoms), a phenylene group, an aralkylene group (having 7-12 carbon atoms) and groups represented by —COO-L-, —CONH-L- or —CONR-L-. Here, L represents an alkylene group (having 1-6 carbon atoms), an arylene group (having 6-12 carbon atoms), or an aralkylene group (having 7-12 carbon atoms). R is an alkyl group (having 1-6 carbon atoms).

G represents Structural formula (A) shown below, wherein each of R₂, R₃, R₄, R₅, R₆, R₇, R₈, and R₉ denotes a hydrogen atom, an alkyl group (1-12 carbon atoms), an aryl group (6-20 carbon atoms), or an aralkyl group (having 7-20 carbon atoms). These may be the same or different and also may have one or more substituents. X is an anion. Two or more groups arbitrarily selected from the group of Q, R₂, R₃, and R₄ or from the group of Q, R₅, R₆, R₇, R₈, and R₉ may be combined with each other to form a ring structure together with a nitrogen atom.

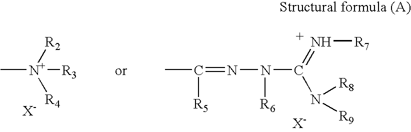

Examples of the monomer in A include divinylbenzene, ethylene glycol dimethacrylate, and the monomers disclosed in paragraph 0018 of the above-mentioned patent publication.

Examples of the ethylenically-unsaturated monomer in B include styrene, n-butyl methacrylate, methyl methacrylate, and the monomers disclosed in paragraphs 0019-0021 of the above-mentioned patent publication.

Examples desirable for R₁ include a hydrogen atom, a methyl group, and the groups disclosed in paragraph 0022 of the above-mentioned patent publication. Examples desirable for Q include alkylene groups such as —CH₂— and —CH₂)₆—, a phenylene group, a p-phenylenemethylene group, and groups disclosed in paragraph 0022 of the above-mentioned patent publication.

Examples of the alkyl group represented by R₂ to R₉ in Structural formula (A) referred to above include a methyl group, an ethyl group, a n-propyl group, and the groups disclosed in paragraph 0027 of the above-mentioned patent publication. Examples of the aryl group include a phenyl group, a naphthyl group, and the groups disclosed in paragraph 0028 of the above-mentioned patent publication. Examples of the aralkyl group include a benzyl group, a phenethyl group, and the groups disclosed in paragraph 0029 of the above-mentioned patent publication. In addition, the ions as disclosed in paragraph 0030 of the publication are given as X in addition to a chlorine ion, an acetate ion and a sulfate ion.

The aforementioned (co)polymer contains at least the monomer unit(s) c), the content of which is from 0.1 to 100 mol %, preferably from 0.5 to 50 mol %, and particularly preferably from 1 to 30 mol % relative to the (co)polymer. When the copolymer contains the monomer unit(s) a), the content thereof is from 1 to 20 mol % relative to the (co)polymer. When the copolymer contains the monomer unit(s) b), the content thereof is from 0.1 to 99.9 mol % relative to the (co)polymer.

Specific examples of usable polymers represented by Formula (1) above include copolymers P-1 to P-23 disclosed in paragraphs 0037-0041 of the above-mentioned publication and variations of these copolymers, in which the molar ratios of the coplymerizing monomers are appropriately varied.

Examples of usable dispersions of a positively charged polymer include base latex disclosed from line 5 in column 6 in page 3 to line 5 in column 18 in page 9 of JP-B No. 62-11678 and cationic polymer particles/particulates disclosed from line 28 in column 2 in page 2 to line 1 in column 5 in page 4 of JP-A No. 5-306314, those disclosed from line 6 in column 3 in page 3 to line 41 in column 6 in page 4 of JP-A No. 9-99632, those disclosed from line 33 in column 9 in page 6 to line 3 in column 12 in page 7 of JP-A No. 11-348416, those disclosed from line 12 in page 24 to line 9 in page 27 of WO00/6390, those disclosed from line 2 in column 4 in page 3 to line 40 in column 8 in page 5 of JP-A No. 2001-106732, those disclosed from line 23 in column 6 in page 4 to line 47 in column 19 in page 11 of JP-A No. 2002-67495, those disclosed from line 33 in column 14 in page 8 to line 20 in column 18 in page 10 of JP-A No. 2002-172854, those disclosed from line 45 in column 8 in page 5 to line 23 in column 9 in page 6 of JP-A No. 2002-225414, those disclosed from line 3 in column 3 in page 3 to line 2 in column 6 in page 4 of JP-A No. 2002-292993, and those disclosed from line 24 to line 35 in column 33 in page 18 of JP-A No. 2001-347338.

When hydrophobic groups of polymerizable monomers having a hydrophobic group, such as an alkyl group, an aryl group, or an aralkyl group, are exposed in the surface of the aforementioned polymer particles/particulates, crosslinking coagulation occurs more easily. Examples of the particles/particulates whose hydrophobic groups are exposed on the surface thereof include the monomer unit c) in which at least one of R₁, R₂, R₃, R₄, R₅, R₆, R₇, R₈, and R₉ is a substituent that has 4 or more carbon atoms, which may specifically be an alkyl group, an aryl group, or an aralkyl group.

Examples of the inorganic particles/particulates having a positive charge include particles/particulates of zinc oxide, magnesium oxide, zirconium oxide, aluminum oxide, aluminum hydroxide, etc. Further, by being subjected to surface modification or surface substitution with a polyvalent ion of a metal such as aluminum or a quaternary salt compound or a primary, secondary, or tertiary amino group, particles/particulates having an electrically neutral surface or having a negative charge (e.g., silica particles, calcium carbonate particles/particulates and barium sulfate particles/particulates) can be used in the form of particles/particulates having a positive charge.

Moreover, as the aforementioned inorganic particles/particulates having a positive charge, laminar (tabular) particles/particulates having a positive charge, e.g., hydrotalcite, may be used.

The laminar (tabular) particles/particulates have an aspect ratio of from 3 to 1000, preferably from 4 to 500, and particularly preferably from 5 to 300.

Particles/Particulates Having a Negative Charge

As particles/particulates having a negative charge in the first embodiment, both organic particles/particulates and inorganic particles/particulates are usable. In the second embodiment, the particles/particulates having a negative charge are organic particles/particulates, and preferably are thermoplastic organic particles/particulates. Examples of the particles/particulates having a negative charge which are suitably usable as the aforementioned particles/particulates include thermoplastic polymer particles/particulates having thereon an anionic group such as a —COOH group, a —SO₃H group, a —SO₂H group, a —SO₄H group, and a —PO₄H group, or salts of the groups (e.g., alkali metal salts, NH₄⁺ salt, quaternary ammonium salt). When it is required that an amount of the electric charge of the particles/particulates be controlled by controlling the pH, polymer particles/particulates having a —COOH group (or salts thereof) is preferably used. Specific examples of the particles/particulates having a negative charge include particles/particulates of polymer having an anionic group such as polyurethane, polyester, polyacrylic acid ester, and polymethacrylic acid ester.

A dispersion of negatively charged polymer is usable as the thermoplastic polymer particles/particulates having a negative charge.

The dispersion of a negatively charged polymer may be a polymer made from polymerizable monomers having an anionic group such as those mentioned above. Examples of the polymerizable monomers having an anionic group include α,β-ethylenically unsaturated monocarboxylic acid, α,β-ethylenically unsaturated dicarboxylic acid or its monoalkyl ester, wherein the alkyl group thereof has 1 to 12 carbon atoms, or products obtained by polymerizing monomers in which an anionic group substitutes the alkyl group of the alkyl ester moiety. Further, the monomers include α,β-ethylenically unsaturated dicarboxylic acid monoamide in which an anionic group-substituted alkyl group substitutes the N atom, wherein the alkyl group has 1 to 12 carbon atoms. Examples of the α,β-ethylenically unsaturated monocarboxylic acid include an acrylic acid, a methacrylic acid, and a crotonic acid. Examples of the α,β-ethylenically unsaturated dicarboxylic acid include a maleic acid and a fumaric acid.

In addition, monomers in which an anionic group substitutes styrene (phenyl-substitution, β-position substitution) may also be used.

Products obtained by further copolymerizing the aforementioned anionic group-containing monomers with other monomers are preferably used. Examples of the other monomers include α,β-ethylenically unsaturated monocarboxylic acid alkyl ester, wherein the alkyl group has 1 to 12 carbon atoms, α,β-ethylenically unsaturated dicarboxylic acid dialkyl ester, wherein the alkyl group has 1 to 12 carbon atoms, styrene, divinylbenzene, vinyl ether, vinyl thioether and vinyl halide. Examples of the α,β-ethylenically unsaturated monocarboxylic acid include an acrylic acid, a methacrylic acid and a crotonic acid. Examples of the α,β-ethylenically unsaturated dicarboxylic acid include a maleic acid and a fumaric acid.

The content of the anionic group-containing polymerizable monomer units in the polymer constituting the aforementioned particles/particulates is from 0.1 to 100 mol %, preferably from 0.5 to 50 mol %, and particularly preferably from 1 to 30 mol %.

Among the copolymers disclosed in pages 231-239 of JP-A 62-215272, the anionic group-containing copolymers named E-4, E-11 to E-19, E-20, E-22, and E-23 in page 239 may be used as specific copolymers. Further, variations of those copolymers, having the molar ratio of copolymerized monomers appropriately differed, may also be used.

Moreover, examples of the thermoplastic polymer particles/particulates having a negative charge include those disclosed from line 6 in column 9 in page 6 to line 25 in column 15 in page 9 of JP-A No. 6-266040, those disclosed from line 22 in column 5 in page 4 to line 1 in column 7 in page 5 of JP-A No. 2002-365767, and those disclosed from line 23 in column 11 in page 7 to line 9 in column 14 in page 8 of JP-A No. 2003-94597.

If a hydrophobic group, such as an alkyl group, an aryl group, or an aralkyl group of polymerizable monomers having such a group is exposed on the surface of the polymer particles/particulates, crosslinking coagulation occurs more easily. Specific examples of the particles/particulates in which a hydrophobic group is exposed on their surface include polymer particles/particulates obtained by polymerizing monomers containing polymerizable monomers having an alkyl group, an aryl group, or an aralkyl group having 4 or more carbon atoms in polymerizable monomer units having an anionic group.

The weight-average molecular weight (Mw) of the aforementioned polymer is suitably approximately from 3,000 to 100,000, and preferably approximately from 5,000 to 50,000.

Examples of the inorganic particles/particulates having a negative charge include silica particles/particulates. Moreover, even if the surface is electrically neutral or is positively charged, the particles/particulates can be converted into particles/particulates having a negative charge when subjected to surface modification or surface substitution with compounds having —COO⁻group or —SO₃⁻ group.

As the inorganic particles/particulates having a negative charge, clay minerals may also be used such as laminar (tabular) particles/particulates, e.g. swellable synthetic mica (trade name: SOMASIF ME100, manufactured by CO-OP Chemical Co., Ltd.), non-swellable mica (trade name: SOMASIF MK100, manufactured by CO-OP Chemical Co., Ltd.), talc, and montmorillonite.

The laminar (tabular) particles/particulates have an aspect ratio of from 3 to 2000, preferably from 5 to 1000, and particularly preferably from 10 to 500.

Water-Soluble Polymer Having a Positive Charge

A thermoplastic water-soluble polymer is preferably used for the water-soluble polymer having a positive charge. Examples thereof include water-soluble polyurethane compound polymers, water-soluble polyester compound polymers, water-soluble polyacrylic acid ester compound polymers, water-soluble polymethacrylic acid ester compound polymers and water-soluble polystyrene compound polymers, each of which has at least one selected from a primary, secondary, or tertiary amino group, an imino group, salts of a primary to tertiary amino group or an imino group, a quaternary ammonium salt group or a pyridinium salt group on the main chain or side chain thereof.

The content of polymerizable monomer units having at least one selected from a primary to tertiary amino group, an imino group, salts of a primary to tertiary amino group or an imino group, a quaternary ammonium salt group or a pyridinium salt group in the polymer is from 1 to 100 mol %, preferably from 3 to 50 mol %, and particularly preferably from 5 to 40 mol %.

When water-solubility of the polymer is insufficient because of a small proportion of cationic groups contained therein, nonionic water-soluble groups, such as a hydroxy group, an ethylene oxide group, or a propylene oxide group, may be introduced. The weight-average molecular weight (Mw) of the polymer is preferably approximately from 500 to 100,000, and more preferably approximately from 10,000 to 50,000.

Examples of the thermoplastic water-soluble polymer having a positive charge include those represented by the following Formula (2). B, R₁, Q, and G in Formula (2) have the same meanings as those in Formula (1). The aforementioned (co)polymer contains at least monomer unit c), the content of which is from 1 to 100 mol %, preferably from 3 to 50 mol %, and more preferably from 5 to 40 mol %. When the copolymer contains the monomer unit represented by B in Formula (2), the content thereof is from 0.1 to 99 mol %.

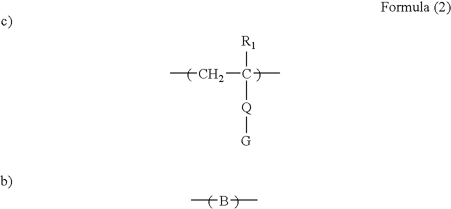

Specific examples of usable (co)polymer represented by Formula (2) include polymers and copolymers PA-1 to PA-19 disclosed in paragraphs 0042-0045 of JP-A No. 9-114066 and variations of these in which the molar ratio of copolymerized monomers is appropriately varied.

When hydrophobic groups of the water-soluble polymer, such as an alkyl group, an aryl group, or an aralkyl group, are exposed in the surface of the polymer, crosslinking coagulation occurs more easily. Examples of the water-soluble polymer whose hydrophobic groups are exposed on the surface thereof may specifically include water-soluble polymers consisting of polymerizable monomer units having cationic groups which are polymerized with polymerizable monomers that have an alkyl group, an aryl group, or an aralkyl group having 4 or more carbon atoms.

Water-Soluble Polymer Having a Negative Charge

As the water-soluble polymer having a negative charge, thermoplastic water-soluble polymers are preferably used. Examples thereof include water-soluble polyurethane compound polymers, water-soluble polyester compound polymers, water-soluble polyacrylic acid ester compound polymers, water-soluble polymethacrylic acid ester compound polymers and water-soluble polystyrene compound polymers, each of which has an anionic group such as —COOH group, —SO₃H group, —SO₄H group, —SO₂H group, —PO₄H₂ group or salts of these groups (e.g., alkali metal salts, NH₄⁺ salts, quaternary ammonium salts).

In the aforementioned polymer, the content of polymerizable monomer units having an anionic group is from 0.1 to 100 mol %, preferably from 0.5 to 50 mol %, and particularly preferably from 1 to 30 mol %.

When water-solubility of the polymer is insufficient because of a small proportion of cationic groups contained therein, nonionic water-soluble groups, such as a hydroxy group, an ethylene oxide group, or a propylene oxide group, may be introduced.

The weight-average molecular weight (Mw) of the polymer is suitably approximately from 1,000 to 100,000, and more preferably approximately from 2,000 to 50,000.

Examples of the thermoplastic water-soluble polymer having a negative charge include polymers made from polymerizable monomers having an anionic group such as those mentioned above, and copolymers made from the foregoing polymerizable monomers and other polymerizable monomers.

Examples of the polymerizable monomers having an anionic group include unsaturated mono- or dicarboxylic acids such as an acrylic acid, a methacrylic acid, a crotonic acid, a fumaric acid and a maleic acid, anionic group-substituted styrenes (substituted at phenyl group, [symbol] -position, etc.), alkyl esters of the foregoing unsaturated mono- or dicarboxylic acids wherein 1 or 2 or more anionic groups substitute the alkyl group, and alkyl-substituted amides of the foregoing unsaturated mono- or dicarboxylic acids wherein 1 or 2 or more anionic groups substitute the alkyl group. Examples of the other polymerizable monomers to be copolymerized with the polymerizable monomers having an anionic group include alkyl esters of the aforementioned unsaturated monocarboxylic acids wherein the alkyl group has from 1 to 12 carbon atoms, alkyl-substituted amides wherein the alkyl group has from 1 to 12 carbon atoms, dialkyl esters of the aforementioned unsaturated dicarboxylic acids wherein the alkyl group has from 1 to 12 carbon atoms, vinyl esters (e.g., vinyl acetate and vinyl propionate), vinyl ethers (e.g., methyl vinyl ether and butyl vinyl ether), styrenes and acrylonitriles.

Examples of the water-soluble polymer having a negative charge of the invention include polyacrylic acid, sodium salts thereof, polymethacrylic acid and sodium salts thereof.

As the above-mentioned water-soluble polymer having a negative charge, the anionic polymers disclosed from line 12 in the lower-right column in page 2 to the lower-left column in page 6 of JP-A No. 63-103240 are usable. The polymerizable monomers having an anionic group are disclosed from line 9 in the upper-left column to the eleventh line from the bottom of the lower-right column in page 3 of JP-A No. 63-103240. The coplymerizable monomers are disclosed from the sixth line from the bottom of the lower-right column in page 3 to the third line from the bottom of the lower-left column in page 4 of JP-A No. 63-103240.

Specific examples of usable water-soluble polymer having a negative charge in the invention include polymers and copolymers disclosed from the lower-right column in page 4 to the lower-left column in page 6 of JP-A No. 63-103240, and variations of these copolymers, in which the molar ratios of copolymerized monomers are appropriately varied.

Moreover, the water-soluble polymers having an anionic group as disclosed in paragraphs 0009, 0022-0025 and 0033-0037 of JP-A No. 10-48792 may also be employed. In addition, polymers, in which the molar ratio of copolymerized monomers are appropriately varied to form variations of the polymers disclosed in paragraphs 0033-0037 of the above-mentioned publication, are also usable.

When hydrophobic groups of the water-soluble polymer, such as an alkyl group, an aryl group, or an aralkyl group, are exposed in the surface of the polymer, crosslinking coagulation occurs more easily. Examples of the water-soluble polymer whose hydrophobic groups are exposed on the surface thereof may specifically include water-soluble polymers consisting of polymerizable monomer units having anionic groups which are polymerized with polymerizable monomers that have an alkyl group, an aryl group, or an aralkyl group having 4 or more carbon atoms.

The positively-charged or negatively-charged particles/particulates have a particle diameter of from 0.01 to 100 μm, preferably from 0.05 to 50 μm, and more preferably from 0.1 to 25 μm.

When the particles/particulates are in the form of a polymer dispersion, the dispersion diameter is appropriately approximately from 0.01 to 1 μm, preferably from 0.02 to 5 μm, and more preferably from 0.05 to 3 μm. The polymer particles may be any shape such as spherical, tabular, shaped like red blood cells, shaped having a through-hole, and confits-like shape. The dispersion diameter is determined based on measurement using a photograph from a scanning electron microscope.

The ratio of the particles and the water-soluble polymer used is appropriately approximately from 50:50 to 99:1, preferably from 60:40 to 95:5, and more preferably from 65:35 to 90:10.

The preparation of the aforementioned resins (resin dispersions or water-soluble resins) having a cationic group or an anionic group to be used in the invention is generally carried out in aqueous media. In the preparation, surfactants may be used, but it is possible to conduct the preparation without using surfactants, and rather it is preferable to use no surfactants.

It is desirable to use a polymerization initiator. As the polymerization initiator, any substance may be used as long as it produces a free radical. Examples of the polymerization initiator include 2,2′-azobis(2-amidinopropane)dihydrochloride, benzoyl peroxide, azobisisobutyronitrile, cumene hydroperoxide, and t-butyl hydroperoxide.

Further, combinations of these polymerization initiators and reducing agents are suitably used. Furthermore, anionic polymerization initiators such as ammonium persulfate are also usable.

There is no particular limitation on the amount of polymerization initiator to be used. However, it is preferable to use a polymerization initiator in an amount of from 0.05 to 5 mass % based on the total amount of the monomers to give as little residual amount of monomer as possible.

Although there is no particular limitation on the polymerization initiation temperature, it is generally from 30 to 100° C., preferably from 40 to 80° C. A temperature lower than 30° C. may result in a lowering of the rate of polymerization of monomers. A temperature higher than 100° C. may result in a difficulty in conducting a reaction in a water-based system under normal pressure condition.

There are also no particular limitations on the method of adding monomers to a reaction system. For example, the total amount of monomers may be first added to the reaction system. Alternatively, the monomers may be added separately or continuously.

In the second embodiment of the invention, it is desirable that at least one of the organic particles having a charge and the organic particulates having a charge opposite to that of the organic particles contained in the coating liquid be weakly charged. Further, it is also desirable that at least one of the organic particles having a charge and a water-soluble polymer having a charge of a sign opposite to that of the charge of the organic particles be weakly charged. When organic particles or a water-soluble polymer is used, at least one of which being weakly charged, the coatability and the crosslinking coagulatability, which are described later, are easily compatible.

The porous layer in the image-receiving material of the second embodiment of the invention is formed by crosslinking coagulating two kinds of organic grains (namely, organic particles and organic particulates) having opposite charges or organic particles and water-soluble polymer having opposite charges. The crosslinking coagulation more easily occurs when the number of positive charges and the number of negative charges of the charged particles/particles or the charged polymer are the same or similar. However, if too much importance is given to crosslinking coagulation, excessive crosslinking coagulation may occur in the coating liquid, which means that the viscosity of the coating liquid may increase or precipitates may be formed in the coating liquid and thereby the coating liquid may become unsuitable for coating. On the other hand, if too much importance is given to coatability, the coating liquid becomes less liable to crosslinking coagulation and it is difficult to obtain a desirable porous layer. Therefore, in the coating liquid of the invention, it is desirable to make the coatability and the crosslinking coagulatability compatible by rendering at least one of the organic particles having a charge and organic particulates having an opposite charge or at least one of organic particles having a charge and a water-soluble polymer having an opposite charge weakly charged and adjusting the pH of the coating liquid or the pH of the coat layer formed by the application of the coating liquid.

The charge state of the weakly charged anionic group or the weakly charged cationic group changes in a certain pH region. For example, —COOH group is not readily dissociated in a low pH region. However, if the pH is increased over a certain pH region, COO⁻ ions increase in the aqueous medium. Utilization of this property makes it easy to balance the coatability and the crosslinking coagulation characteristic by controlling the amount of COO⁻ ion through adjustment of the pH of the coating liquid, this method hereinafter being called the first method. Alternatively, utilization of that property also makes it easy to optimize the coatability by controlling the pH of the coating liquid at the time of coating so that the amount of COO⁻ ion in the coating liquid becomes small and also to optimize the crosslinking coagulation characteristic by increasing COO⁻ ions through the supply of an alkaline pH regulator to the coat layer after coating, this method being hereinafter called the second method.

By utilizing the aforementioned technique, it becomes possible to optimize the viscosity of the coating liquid and to prevent the coating liquid from forming precipitates in the first and second methods. The viscosity of the coating liquid is preferably from 10 to 500 mPa·s, more preferably from 20 to 300 mPa·s, and particularly preferably from 30 to 250 mPa·s.

In the second embodiment of the invention, “organic particles or water-soluble polymer is weakly charged” means a property wherein the charged group of organic particles or water-soluble polymer, that is, an anionic group or a cationic group, does not exhibit increased dissociation unless an aqueous medium is adjusted to a specific pH region when the organic particles or the water-soluble polymer is dissolved or dispersed in the aqueous medium. “Strongly charged” means that the substance causes high dissociation at any pH of the aqueous medium (having a dissociation constant of 10⁻³ or more).

Among the aforementioned anionic groups, —COOH group, —PO₄H₂ group and their salts are weakly charged anionic groups (weak anionic group). Among the aforementioned cationic groups, primary, secondary, and tertiary amino groups, imino group and salts thereof are weakly charged cationic groups (weak cationic groups). Examples of the strongly charged anionic group (strong cationic group) include —SO₃H group, —SO₄H group, —SO₂H group and their salts. Examples of the strongly charged cationic group (strong cationic group) include a quaternary ammonium salt group and pyridinium salt group.

The following are examples of combinations using at least weakly charged organic particles or weakly charged water-soluble polymer in the second embodiment of the invention:
1) a combination of weak anionic particles and either strong cationic particulates or strong cationic water-soluble polymer (e.g., a combination of POOH group-containing particles and either quaternary ammonium salt group-containing particulates or water-soluble resin polymer)
2) a combination of weak cationic particles and either strong anionic particulates or strong anionic water-soluble polymer (e.g., a combination of —NH₂ group-containing particles and either —SO₃⁻ group-containing particulates or water-soluble resin polymer)
3) a combination of weak anionic particles and either weak cationic particulates or weak cationic water-soluble polymer (e.g., a combination of POOH group-containing particles and either —NH₂ group-containing particulates or water-soluble resin polymer)
4) a combination of weak cationic particles and either weak anionic particulates or weak anionic water-soluble polymer (e.g., a combination of —NH₂ group-containing particles and either —COOH group-containing particulates or water-soluble resin polymer)

Inorganic charged particles may be adde to the porous layer in the second embodiment of the invention d unless the amount thereof exceeds 50% by volume of the layer.

Examples of the inorganic particles having a positive charge include particles of zinc oxide, magnesium oxide, zirconium oxide, aluminum oxide, aluminum hydroxide, etc. Further, by subjecting to surface modification or surface substitution with polyvalent ion of a metal such as aluminum or a quaternary salt compound or a primary to tertiary amino group, particles having an electrically neutral surface or having a negative charge (e.g., silica particles, calcium carbonate particles and barium sulfate particles) can be used in the form of particles having a positive charge.

Moreover, as the aforementioned inorganic particles having a positive charge, laminar (tabular) particles having a positive charge, e.g., hydrotalcite may be used. The average particle diameter of the laminar (tabular) particles is from 0.1 to 30 μm, preferably from 0.2 to 20 μm, and particularly preferably from 0.5 to 10 μm. The aspect ratio of the inorganic particles is from 3 to 1000, preferably from 4 to 500, and particularly preferably from 5 to 300.

Examples of the inorganic particles having a negative charge include silica particles. Moreover, even if the surface is electrically neutral or is positively charged, the particles can be converted into particles having a positive charge when subjected to surface modification or surface substitution with compounds having —COO⁻group or —SO₃^{-group.}

Clay minerals may also be used as the inorganic particles having a negative charge such as laminar (tabular) particles, e.g. swellable synthetic mica (trade name: SOMASIF ME100, manufactured by CO-OP Chemical Co., Ltd.), non-swellable mica (trade name: SOMASIF MK100, manufactured by CO-OP Chemical Co., Ltd.), talc, and montmorillonite.

The average particle diameter of the laminar (tabular) particles is from 0.1 to 30 μm, preferably from 0.2 to 20 μm and particularly preferably from 0.5 to 10 μm. The aspect ratio of the laminar (tabular) particles is from 3 to 2000, preferably from 5 to 1000, and particularly preferably from 10 to 500.

Thermoplastic Binder Resin of Lower Glass Transition Temperature

A binder resin of a low glass transition temperature (Tg) may be added to the porous layer of the invention. The Tg is preferably equal to or less than 25° C. The low Tg binder resin may be used in the form of a polymer dispersion. Even if the binder resin has a Tg higher than 25° C., it can be used as long as it substantially has a Tg not higher than 25° C. from use in combination with an oil plasticizer. When a plasticizer is used, an emulsion of the plasticizer may be mixed with a polymer dispersion and then stirred. Examples of the polymer dispersion include dispersions of polymers such as vinyl acetate compound polymer, ethylene-vinyl acetate compound polymer, acrylic compound polymer, vinylidene chloride compound polymer, vinyl chloride compound polymer, butadiene compound polymer, styrene compound polymer, and polyester compound polymer. Examples of the polymers include an ethyl acrylate polymer, a propyl acrylate polymer, a 2-ethoxyethyl acrylate polymer, a n-butyl acrylate polymer, a propyl acrylate-styrene copolymer and an ethyl acrylate-acrylic acid copolymer.

The low Tg binder dispersion mentioned above is disclosed in detail in paragraphs 0010-0016 of JP-A No. 4-321045.

The addition of the low Tg binder resin strengthens the adhesion of the particles/particulates, resulting in improvement in both film strength and curling property of the material.

Other Additives

When the image-receiving material of the invention is used for ink jet printing, water-soluble binders, mordants, particles (particulates), crosslinking agents and the like which are added to ink-receiving layers of conventionally-known image-receiving materials may arbitrary added to the porous layer and/or layers adjacent thereto.

Water-Soluble Binder

Examples of the water-soluble binder include polyvinyl alcohol resins that are resins having a hydroxy group as a hydrophilic structural unit [such as polyvinyl alcohol (PVA), acetacetyl-modified polyvinyl alcohol, cationic modified polyvinyl alcohol, anionic modified polyvinyl alcohol, silanol-modified polyvinyl alcohol, or polyvinyl acetal], cellulose resins [such as methylcellulose (MC), ethylcellulose (EC), hydroxyethylcellulose (HEC), carboxymethylcellulose (CMC), hydroxypropylcellulose (HPC), hydroxyethylmethylcellulose, or hydroxypropylmethylcellulose], chitins, chitosans, starch, resins having ether bond(s) [such as polyethylene oxide (PEO), polypropylene oxide (PPO), polyethylene glycol (PEG), or polyvinylether (PVE)], resins having carbamoyl group(s) [such as polyacryl amide (PAAM), polyvinylpyrrolidone (PVP), or hydrazine polyacrylate].

Particles (Particulates)

In addition to the aforementioned charged particles/particulates, other organic particles (particulates) and inorganic particle (particulates) may also be employed. Preferable examples of the other organic particles (particulates) include polymer particles (particulates) produced by emulsion polymerization, microemulsion polymerization, soap-free polymerization, seed polymerization, dispersion polymerization, and suspension polymerization, and specific examples thereof include polymer particles (particulates) of polyethylene, polypropylene, polystyrene, polyacrylate, polyaminde, silicone resin, phenol resin, and naturally occurring polymers, in the form of powder, latex or emulsion.

Examples of the other inorganic particles (particulates) include silica particles (particulates), colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, magnesium silicate, zirconia, zirconium hydroxide, cerium oxide, lanthanum oxide and yttrium oxide.

Crosslinking Agent

When the water-soluble resin is polyvinyl alcohol, a boron compound is preferably used as the crosslinking agent. Examples of the boron compound include borax, boric acid, borate (for example, orthoborate, InBO₃, ScBO₃, YBO₃, LaBO₃, Mg₃(BO₃)₂, CO₃(BO₃)₂, diborate (for example, Mg₂B₂O₅, CO₂B₂O₅), metaborate (for example, LiBO₂, Ca(BO₂)₂, NaBO₂, KBO₂), tetraborate (for example, Na₂B₄O₇.10H₂O), pentaborate (for example, KB₅O₈.4H₂O, Ca₂B₆O₁₁.7H₂O, CsB₅O₅), and so on. Among these compounds, borax, boric acid, and borate are preferable, and boric acid is particularly preferable because of their ability of causing the crosslinking reaction rapidly.

As the crosslinking agent for the water-soluble resin, compounds other than the boron compound may also be used.

Example of such compounds include aldehyde compounds such as formaldehyde, glyoxal, succinaldehyde, glutaraldehyde, dialdehyde starch, or plant gum; ketone compounds such as diacetyl, 1,2-cyclopentanedione, or 3-hexene-2,5-dione; active halogen-containing compounds such as bis(2-chloroethyl)urea, bis(2-chloroethyl)sulfone or 2,4-dichloro-6-hydroxy-s-triazine sodium salt; active vinyl compounds such as divinylsulfone, 1,3-bis(vinylsulfonyl)-2-propanol, N,N′-ethylenebis(vinylsulfonylacetamide), divinyl ketone, 1,3-bis(acryloyl)urea, or 1,3,5-triacryloyl-hexahydro-s-triazine; N-methylol compounds such as dimethylol urea or methylol dimethyl hydantoin; melamine compounds such as trimethylol melamine, alkylated methylol melamine, melamine, benzoguanamine, or melamine resin; epoxy compounds such as ethylene glycol diglycidyl ether, propylene glycol diglycidyl ether, polyethylene glycol diglycidyl ether, diglycerin polyglycidyl ether, spiroglycol diglycidyl ether, or polyglycidyl ether of phenol resin; isocyanate compounds such as 1,6-hexamethylenediisocyanate or xylilenediisocyanate; aziridine compounds disclosed in U.S. Pat. Nos. 3,017,280, 2,983,611 and so on; carbodiimide compounds disclosed in U.S. Pat. No. 3,100,704 and so on; ethyleneimino compounds such as 1,6-hexamethylene-N,N′-bisethylene urea; carboxyaldehyde halide compounds such as mucochloric acid or mucophenoxychloric acid; dioxane compounds such as 2,3-dihydroxydioxane; metal-containing compounds such as titanium lactate, aluminum sulfate, chromium alum, potassium alum, zirconyl acetate, or chromium acetate; polyamine compounds such as tetraethylene pentamine; hydrazide compounds such as adipic acid hydrazide; low molecular compounds or polymers containing at least two oxazoline groups; anhydrides of polyvalent acids, acid chlorides, and bissulfonated compounds disclosed in U.S. Pat. Nos. 2,725,294, 2,725,295, 2,726,162, 3,834,902 and so on; and active ester compounds disclosed in U.S. Pat. Nos. 3,542,558 and 3,251,972.

The above crosslinking agents may be used either singly or in combinations of two or more.

Mordant

A mordant is used for fixing an anionic dye to the porous layer. The mordant described below may also be used for forming a porous layer as the aforementioned “particles having a positive charge” or “positively charged water-soluble polymer.”

As the mordant, a cationic polymer (cationic mordant) or an inorganic mordant is preferably used.

As the cationic mordant, a polymer mordant having a primary, secondary, or tertiary amino group or a quaternary ammonium salt group as a cationic group is suitably used. A cationic non-polymer mordant may also be used.

From the viewpoint of improvement in ink absorbability of the porous layer, these mordants are preferably compounds having a weight-average molecular weight of from 500 to 100,000.

As the aforementioned polymer mordant, those obtained as a homopolymer of a monomer (mordant monomer) having primary, secondary, or tertiary amino groups or salts thereof or a quaternary ammonium salt group, or as a copolymer or a condensed polymer of the mordant monomer and other monomers (hereinafter refereed to as “non-mordant monomer”) are preferred. These polymer mordants may be used in any of the forms of a water-soluble polymer and water-dispersible latex particles.

Examples of the aforementioned monomer (mordant monomer) include trimethyl-p-vinylbenzylammonium chloride, trimethyl-m-vinylbenzylammonium chloride, triethyl-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;
trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;
methyl chloride, ethyl chloride, methyl bromide, ethyl bromide, methyl iodide or quaternary compounds of ethyl iodide of N,N-dimethylaminoethyl(meth)acrylate, N,N-diethylaminoethyl(meth)acrylate, N,N-dimethylaminopropyl(meth)acrylate, N,N-diethylaminopropyl(meth)acrylate, N,N-dimethylaminoethyl(meth)acrylamide, N,N-diethylaminoethyl(meth)acrylamide, N,N-dimethylaminopropyl(meth)acrylamide, and N,N-diethylaminopropyl(meth)acrylamide, and sulfonates, alkylsulfonates, acetates or alkylcarboxylates obtained by substituting anions of these compounds.

Specific examples of these salts include monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)-ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(aryloylamino)ethylammonium chloride, trimethyl-3-(methacryloylamino)propylammonium chloride, triethyl-3-(methacryloylamino)propylammonium chloride, trimethyl-3-(acryloylamino) propylammonium chloride, triethyl-3-(acryloylamino)propylammonium chloride,
N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Other than the above, N-vinylimidazole and N-vinyl-2-methylimidazole are provided as examples of a copolymerizable monomer.

Allylamine, diallylamine, allylamine compounds, diallylamine compounds and salts thereof may be also utilized. Examples of these compounds include allylamine, allylamine hydrochloride, allylamine acetate, allylamine sulfate, diallylamine, diallylamine hydrochloride, diallylamine acetate, diallylamine sulfate, diallylmethylamine, and salts thereof (examples of the salts include hydrochlorides, acetates and sulfates), diallylethylamine, and salts thereof (examples of the salt include hydrochlorides, acetates and sulfates), diallyldimethylammonium salts (examples of a counter anion of the salts include chloride, acetate ion and sulfate ion). These allylamine compounds and diallylamine compounds are generally polymerized in the form of salt and then desalted according to the need because they are poor in polymerizing ability when they are in a form of amine.

Further, a vinylamine unit formed by polymerizing units such as N-vinylacetamide or N-vinylformamide and converting them by hydrolysis, and salts of the unit may also be utilized.

The aforementioned non-mordant monomers denote monomers, which are free of a primary, secondary, or tertiary amino group or their salt or a basic or cationic portion such as a quaternary ammonium salt and exert no interaction with a dye contained in ink jet ink or exert a substantially small interaction with the dye.

Examples of the aforementioned non-mordant monomer include alkyl (meth)acrylates; cycloalkyl(meth)acrylates such as cyclohexyl(meth)acrylate; aryl (meth)acrylates such as phenyl(meth)acrylate; aralkyl esters such as benzyl(meth)acrylate; aromatic vinyls such as styrene, vinyltoluene, or [symbol] -methylstyrene; vinyl esters such as vinyl acetate or vinyl propionate; allyl esters such as allyl acetate; halogen-containing monomers such as vinylidene chloride or vinyl chloride; vinyl cyanates such as (meth)acrylonitrile; and olefins such as ethylene or propylene.

As the aforementioned alkyl(meth)acrylate, preferred are alkyl(meth)acrylates having an alkyl group moiety having 1 to 18 carbon atoms, examples of which include methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate, and stearyl (meth)acrylate.

Among these compounds, methyl acrylate, ethyl acrylate, methyl methacrylate, ethyl methacrylate, and hydroxyethyl methacrylate are preferred.

The aforementioned non-mordant monomers may be used either singly or in combinations of two or more.

Other preferred examples of the polymer mordant include polydiallyldimethylammonium chloride, copolymers of diallyldimethylammonium chloride, and other monomer (mordant monomer and non-mordant monomer), diallyldimethylammonium chloride-SO₂ copolymer, cyclic amine resin, and modified compounds thereof (including copolymers thereof) such as typically polydiallylmethylamine hydrochloride, or polydiallyl hydrochloride; secondary amino-, tertiary amino- or quaternary ammonium salt-substituted alkyl(meth)acrylate polymers and their copolymers with other monomer such as typically polydiethylmethacryloyloxyethylamine, polytrimethylmethacryloyloxyethylammonium chloride, polydimethylbenzylmethacryloyloxyethylammonium chloride, or polydimethylhydroxyethylacryloyloxyethylammonium chloride; polyamine resin such as typically polyethylenimine and its polyethylenimine compounds, polyallylamine and polyallylamine compounds, or polyvinylamine and polyvinylamine compounds; polyamide resin such as typically polyamide-polyamine resin or polyamidepichlorohydrine resin; polysaccharide such as typically cationated starch, chitosan or its chitosan compounds; dicyandiamide compounds such as typically dicyandiamide-formalin polycondensate or dicyandiamide-diethylenetriamine polycondensate; polyamidine and polyamidine compounds; dialkylamine-epichlorohydrin addition polymer products such as typically dimethylamine-epichlorohydrin addition polymer products; and polystyrene having a quaternary ammonium salt-substituted alkyl group and its copolymers with other monomer.

Specific examples of the polymer mordant include those disclosed in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134 and 1-161236, each specification of U.S. Pat. Nos. 2,484,430, 2,548,564, 3,148,061, 3,309,690, 4,115,124, 4,124,386, 4,193,800, 4,273,853, 4,282,305 and 4,450,224, JP-A Nos. 1-161236, 10-81064, 10-157277, 10-217601, 2001-138621, 2000-211235, 2001-138627, 8-174992, JP-B Nos. 5-35162, 5-35163, 5-35164, 5-88846, and each specification of Japanese Patent Nos. 2648847 and 2661677.

As the mordant of the invention, inorganic mordants may be employed, examples of which include polyvalent water-soluble metal salts and hydrophobic metal salt compounds.

Specific examples of the inorganic mordants include salts or complexes of metal selected from the group consisting of magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Specific preferable examples include calcium acetate, calcium chloride, calcium formate, calcium sulfate, barium acetate, barium sulfate, barium phosphate, manganese chloride, manganese acetate, manganese formate dihydrate, manganese sulfate ammonium hexahydrate, cupric chloride, ammonium chloride cupper (II) dihydrate, cupper sulfate, cobalt chloride, cobalt thiocyanate, cobalt sulfate, nickel sulfate hexahydrate, nickel chloride hexahydrate, nickel acetate tetrahydrate, nickel sulfate ammonium hexahydrate, nickel sulfate amide tetrahydrate, aluminum sulfate, alum aluminum, aluminum sulfite, thioaluminum sulfate, aluminum polychloride, aluminum nitrate nonahydrate, aluminum chloride hexahydrate, basic aluminum sulfate, basic aluminum nitrate, basic aluminum formate, basic aluminum acetate, basic aluminum glycinate, ferrous bromide, ferrous chloride, ferric chloride, ferrous sulfate, ferric sulfate, zinc phenol sulfonate, zinc bromide, zinc chloride, zinc nitrate hexahydrate, zinc sulfate, titanium tetrachloride, tetraisopropyl titanate, titanium acetylacetate, titanium lactate, zirconium acetylacetate, zirconyl acetate, zirconyl sulfate, zirconium ammonium carbonate, zirconyl stearate, zirconyl octylate, zirconyl nitrate, zirconium oxychloride, zirconium hydroxychloride, zirconyl lactate, zirconyl succinate, zirconyl oxalate, zirconium ammonium acetate, zirconium potassium carbonate, basic zirconium glycinate, chromium acetate, chromium sulfate, magnesium sulfate, magnesium chloride hexahydrate, magnesium citrate nonahydrate, sodium phosphorus wolframate, sodium tungsten citrate, 12-tungstophosphate n-hydrate, 12-tungstosilicate 26 hydrate, molybdenum chloride, 12-molybdophosphate n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, and bismuth nitrate.

As the inorganic mordant for the invention, aluminum-containing compounds, titanium-containing compounds, zirconium-containing compounds, and compounds of metals (salts or complexes) in group IIIB elements in the periodic table of the elements are preferred.

When such a mordant is used as a fixing agent for anionic dyes, it is also possible to apply a coating liquid for forming a porous layer and, after or during the drying of the liquid, apply another liquid containing a mordant by dipping, curtain coating, extrusion coating, or the like.

Other Components

The ink jet printing material of the invention may, as needed, further contain various conventionally-known additives such as acids, UV absorbers, antioxidants, fluorescent brightening agents, monomers, polymerization initiators, polymerization inhibitors, bleeding inhibitors, antiseptics, viscosity stabilizing agents, antifoaming agents, surfactants, antistatic agents, matting agents, curling inhibitors, and water-resistance improvers.

Acid

Examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metallic salts (salts of, for example, Zn, Al, Ca, or Mg) of salicylic acid, methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcilic acid, β-resorcilic acid, γ-resorcilic acid, gallic acid, fluoroglycine, sulfosalicylic acid, ascorbic acid, erythorbic acid, bisphenolic acid, hydrochloric acid, nitric acid, sulfuric acid, phosphoric acid, polyphosphoric acid, boric acid, and boronic acid. The amount of these acids may be defined so as to allow the surface pH of the porous layer to fall within a range from 3 to 8.

The acid may also be used in the form of a metallic salt, examples of which include salts of sodium, potassium, calcium, cesium, zinc, copper, iron, aluminum, zirconium, lanthanum, yttrium, magnesium, strontium, and cerium, or an amine salt, examples of which include salts of ammonia, triethylamine, tributylamine, piperazine, 2-methylpiperazine, and polyallylamine. Examples of the metallic salt include polyaluminum chloride, zirconium oxychloride, and zirconium acetate.

UV Absorber, Antioxidant and Bleeding Inhibitor

Examples include alkylated phenol compounds, which include hindered phenol compounds, alkylthiomethylphenol compounds, hydroquinone compounds, alkylated hydroquinone compounds, tocopherol compounds, aliphatic, aromatic and/or heterocyclic compounds having a thioether linkage, bisphenol compounds, O—, N—, and S-benzyl compounds, hydroxybenzyl compounds, triazine compounds, phosphonate compounds, acylaminophenol compounds, ester compounds, amide compounds, ascorbic acid, amine antioxidants, 2-(2-hydroxyphenyl)benzotriazole compounds, 2-hydroxybenzophenone compounds, acrylates, water-soluble or hydrophobic metallic salts, organometallic compounds, metallic complexes, hindered amine compounds, which include TEMPO compounds, 22-hydroxyphenyl)-1,3,5-triazine compounds, metal deactivators, phosphite compounds, phosphonite compounds, hydroxyamine compounds, nitron compounds, peroxide scavengers, polyamide stabilizers, polyether compounds, basic auxiliary stabilizers, nucleating agents, benzofuranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, and trihydroxybenzoic acid compounds.

Among these compounds, preferred are, for example, alkylated phenol compounds, aliphatic, aromatic and/or heterocyclic compounds having a thioether linkage, bisphenol compounds, ascorbic acid, amine antioxidants, water-soluble or hydrophobic metallic salts, organometallic compounds, metal complexes, hindered amine compounds, hydroxyamine compounds, polyamine compounds, thiourea compounds, hydrazide compounds, hydroxybenzoic acid compounds, dihydroxybenzoic acid compounds, and trihydroxybenzoic acid compounds.

Specific examples of the compounds include those disclosed, for example, in the following publications: Japanese Patent Application No. 2002-13005, JP-A Nos. 10-182621, 2001-260519, JP-B Nos. 4-34953 and 4-34513, JP-A No. 11-170686, JP-B No. 4-34512, EP Patent Publication No. 1138509, JP-A Nos. 60-67190, 7-276808, 2001-94829, 47-10537, 58-111942, 58-212844, 59-19945, 59-46646, 59-109055, 63-53544, JP-B Nos. 36-10466, 42-26187, 48-30492, 48-31255, 48-41572, 48-54965 and 50-10726; U.S. Pat. Nos. 2,719,086, 3,707,375, 3,754,919, 4,220,711,

JP-B Nos. 45-4699, 54-5324, EP Laid-Open Nos. 223739, 309401, 309402, 310551, 310552 and 459416; German Patent Application Said-Open No. 3435443; JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 63-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-170361, JP-B Nos. 48-43295 and 48-33212; and U.S. Pat. Nos. 4,814,262, and 4,980,275.

The aforementioned “other components” may be used singly or in combination of two or more. The “other components” may be added after being water-solubilized, dispersed, polymer-dispersed, emulsified or formed into oil drops. They may also be enclosed in microcapsules. The amount of the “other components” added to the ink jet printing material of the invention is preferably from 0.01 to 10 g/m².

In the invention, the coating liquid for the porous layer preferably contains a surfactant. As the surfactant, any of cationic, anionic, nonionic, amphoteric, fluorine-containing, and silicon-containing surfactants may be used.

Examples of the above nonionic surfactant include polyoxyalkylene alkyl ethers and polyoxyalkylene alkylphenyl ethers (e.g., diethylene glycol monoethyl ether, diethylene glycol diethyl ether, polyoxyethylene lauryl ether, polyoxyethylene stearyl ether and polyoxyethylene nonylphenyl ether), oxyethylene-oxypropylene block copolymers, sorbitan fatty acid esters (e.g., sorbitan monolaurate, sorbitan monooleate and sorbitan trioleate), polyoxyethylenesorbitan fatty acid esters (e.g., polyoxyethylenesorbitan monolaurate, polyoxyethylenesorbitan monooleate and polyoxyethylenesorbitan trioleate), polyoxyethylenesorbitol fatty acid esters (e.g., polyoxyethylenesorbitol tetraoleate), glycerol fatty acid esters (e.g., glycerol monooleate), polyoxyethyleneglycerol fatty acid esters (e.g., polyoxyethyleneglycerol monostearate and polyoxyethyleneglycerol monooleate), polyoxyethylene fatty acid esters (polyethylene glycol monolaurate and polyethylene glycol monooleate), polyoxyethylenealkylamine and acetylene glycols (e.g., 2,4,7,9-tetramethyl-5-decyne-4,7-diol, ethyleneoxide adducts thereof and propyleneoxide adducts thereof). Among these compounds, the polyoxyalkylene alkyl ethers are preferred. The nonionic surfactant may be used in the first coating liquid and in the second coating liquid. The above nonionic surfactants may be used either singly or in combinations of two or more.

Examples of the amphoteric surfactant include those of the amino acid compound, the carboxyammoniumbetaine compound, the sulfonammoniumbetaine compound, the ammonium sulfate betaine compound, and the imidazolium betaine compound. Those disclosed in U.S. Pat. No. 3,843,368, JP-A Nos. 59-49535, 63-236546, 5-303205, 8-262742 and 10-282619, Japanese Patent Nos. 2514194 and 2759795, and JP-A No. 2000-351269 may be suitably used. Among the aforementioned amphoteric surfactants, those of the amino acid compound, the carboxyammoniumbetaine compound, and the sulfonammoniumbetaine compound are preferable. The amphoteric surfactants may be used either singly or in combinations of two or more.

Examples of the aforementioned anionic surfactant include fatty acid salts (e.g., sodium stearate and potassium oleate), alkyl sulfates (e.g., sodium laurylsulfate and triethanolamine laurylsulfate), sulfonates (e.g., sodium dodecylbenzenesulfonate), alkyl sulfosuccinates (e.g., sodium dioctylsulfosuccinate), alkyl diphenyl ether disulfonates, and alkyl phosphates.

Examples of the aforementioned cationic surfactant include alkylamine salts, quaternary ammonium salts, pyridinium salts, and imidazolium salts.

Examples of the aforementioned fluorine-containing surfactant include compounds derived through an intermediate having a perfluoroalkyl group by use of a method such as electrolytic fluorination, telomerization, or oligomerization.

Examples thereof include perfluoroalkyl sulfonates, perfluoroalkyl carboxylates, perfluoroalkylethylene oxide adducts, perfluoroalkyltrialammonium salts, perfluoroalkyl group-containing oligomers, and perfluoroalkyl phosphates.

As the aforementioned silicone compound surfactant, preferred is an organic group-modified silicone oil, which may have a structure in which the side chain of the siloxane structure is modified with an organic group, a structure in which both terminals are modified or a structure in which one terminal is modified. Examples of the organic group modification include amino modification, polyether modification, epoxy modification, carboxyl modification, carbinol modification, alkyl modification, aralkyl modification, phenol modification, and fluorine modification.

The content of the surfactant in the invention is preferably from 0.001 to 2.0% and more preferably from 0.01 to 1.0% based on the coating liquid for the porous layer. When application is effected using two or more liquids are used as the coating liquid for the porous layer, it is desirable to add the surfactant to each coating liquid.

The porous layer may contain a organic solvent having a high-boiling point for prevention of curling and/or regulation of glass transition temperature. The organic solvent having a high-boiling point is a water-soluble or hydrophobic organic compound having a boiling point not lower than 150° C. under normal pressure. The organic solvent may be liquid or solid at room temperature and may be a low molecule or a high molecule.

Specific examples of the organic solvent include aromatic carboxylates (e.g., dibutyl phthalate, diphenyl phthalate and phenyl benzoate), aliphatic carboxylates (e.g., dioctyl adipate, dibutyl sebacate, methyl stearate, dibutyl maleate, dibutyl fumarate and triethyl acetylcitrate), phosphates (e.g., trioctyl phosphate and tricrezyl phosphate), epoxies (e.g., epoxidated soybean oil and epoxidated fatty acid methyl), alcohols (e.g., stearyl alcohol, ethylene glycol, propylene glycol, diethylene glycol, triethylene glycol, glycerol, diethylene glycol monobutyl ether (DEGMBE), triethylene glycol monobutyl ether, glycerol monomethyl ether, 1,2,3-butanetriol, 1,2,4-butanetriol, 1,2,4-pentanetriol, 1,2,6-hexanetriol, thiodiglycol, triethanolamine and polyethylene glycol), vegetable oils (e.g., soybean oil and sunflower oil), and higher aliphatic carboxylic acids (e.g., linoleic acid and oleic acid).

Support

As the support in the invention, either a transparent support made of transparent materials such as plastics or an opaque support made of opaque material such as paper may be used. In order to increase the ink absorption speed of the porous layer, it is preferable to use paper. It is also possible to use, as the support, read-only optical disks such as CD-ROM and DVD-ROM, write-once optical disks such as CD-R and DVD-R, and rewritable optical disks, and to provide them with the porous layer on a labeling surface side.

Materials usable for the aforementioned transparent support are preferably those which are transparent and have qualities enough to endure radiant heat when being used for OHPs and back light displays. Examples of such materials include polyesters such as polyethylene terephthalate (PET); polysulfones, polyphenylene oxides, polyimides, polycarbonates, or polyamides. Among these materials, polyesters are preferred and polyethylene terephthalate is particularly preferred.

Although there are no particular limitations on the thickness of the aforementioned transparent support, the thickness is preferably from 50 to 200 μm from the viewpoint of easiness of handling.

As a highly glossy opaque support, preferred are supports with a surface on which the porous layer is disposed having a glossiness of 40% or more. The aforementioned glossiness is defined as a value determined according to the method provided in the test method for 75° specular glossiness of paper and paper board. The following supports are provided as specific examples.

The examples include highly glossy paper supports such as art paper, coated paper, cast coated paper and baryta paper which are used for a silver salt photographic supports; highly glossy films, which may be processed by surface calender treatment, that are prepared and made opaque by making a plastic film such as polyesters, such as polyethylene terephthalate (PET), cellulose esters such as nitrocellulose, cellulose acetate, and cellulose acetate butyratein, contain a white pigment;
or supports prepared by forming a polyolefin coat layer containing or not containing white pigment on each surface of the aforementioned various kinds of paper support, the aforementioned transparent supports or highly glossy films containing white pigment, etc.

White pigment-containing foam polyester films (e.g., foam PET prepared by making a film contain polyolefin fine particles and forming voids by stretching) may be given as preferable examples. Moreover, resin-coated paper, which is used for silver salt photographic print paper, is also suitable.

Although there are no particular limitations on a thickness of the aforementioned opaque support, the thickness is preferably from 50 to 300 μm in view of easiness of handling.

For the improvement in wettability and adhesiveness, the aforementioned support may be subjected to corona discharge treatment, glow discharge treatment, flame treatment or ultraviolet radiation treatment on its surface before the use of the support.

Next, base paper to be used for the aforementioned resin coat paper will be explained in detail.

The aforementioned base paper is made using wood pulp as a major raw material and, as required, synthetic pulp such as polypropylene or synthetic fiber such as nylon and polyester in addition to the wood pulp. Although any of LBKP, LBSP, NBKP, NBSP, LDP, NDP, LUKP and NUKP may be used as the wood pulp, it is desirable to use LBKP, NBSP, LBSP, NDP, and LDP, which are rich in short fiber, in a relatively large amount.

Regarding above, the ratio of LBSP and/or LDP is preferably from 10 to 70 mass % of the base paper.

As the aforementioned pulp, chemical pulps (e.g., sulfate pulp and sulfite pulp), which are of little impurities, are preferably used and pulps which have been improved in whiteness through bleaching treatment are useful.

To the base paper, sizing agents such as higher fatty acid and alkylketene dimer, white pigments such as calcium carbonate, talc and titanium oxide, paper strength additives such as starch, polyacrylamide and polyvinyl alcohol, fluorescent whiteners, water retentive agents such as polyethylene glycol, dispersants, softening agents such as quaternary ammonium, and the like may optionally be added.

The pulp for use in paper making preferably has a freeness of 200 ml to 500 ml according to the provision of the CSF. Regarding the fiber length after beating, the total of mass percentages of 24-mesh residue and that of 42-mesh residue as specified according to a conventional method known as the method of screening test of paper pulp is preferably from 30 to 70 mass %. The content of 4-mesh residue is preferably 20 mass % or less.

The basis weight of the base paper is preferably from 30 to 250 g and particularly preferably from 50 to 200 g. The thickness of the base paper is preferably from 40 to 250 μm. The base paper may be provided with high smoothness by calendering in a paper-making stage or after paper-making. The density of the base paper is usually from 0.7 to 1.2 g/m² as measured according to a conventional method known as the method for paper-determination of thickness and density.

Further, the rigidity of the base paper is preferably from 20 to 200 g as measured according to a conventional method known as the method of paper-detemination of stiffness by Clark stiffness tester.

A surface sizing agent may be applied to the surface of the base paper. As the surface sizing agent, sizing agents the same as those which may be added to the aforementioned base paper are usable.

The pH of the base paper is preferably from 5 to 9 when measured using a conventional hot-water extraction method.

The polyethylene with which the front surface and back surface of the base paper are coated is primarily low density polyethylene (LDPE) and/or high density polyethylene (HDPE). In addition, LLDPE, polypropylene and the like may also be used as a part of the polyethylene.

Particularly, the polyethylene layer on the side on which the porous layer is formed is preferably improved in opacity, whiteness and hue by addition of titanium oxide having a rutile structure or an anatase structure, a fluorescent whitener and ultramarine blue to polyethylene in the manner in which photographic print paper in a wide field is processed. Here, the content of titanium oxide is preferably from about 3 to about 20 mass % and more preferably from 4 to 13 mass % based on the polyethylene. Although there are no particular limitations on the thickness of the polyethylene layer, it is preferably from 10 to 50 μm on both of the front surface and the back surface. Further, an undercoat layer may be disposed on the polyethylene layer to impart adhesion to the porous layer. As the undercoat layer, an aqueous polyester, gelatin and PVA are preferred. The thickness of the undercoat layer is preferably from 0.01 to 5 μm.

The polyethylene coated paper may be used in the form of glossy paper. Alternatively, polyethylene coated paper formed with a matted surface or silky pattern surface, which is obtained from usual photographic print paper, by performing so-called marking treatment when polyethylene is melt-extruded on the surface of the base paper to effect coating may also be used. Although the polyethylene layer is usually subjected to a lamination process by melt-extrusion, it may also be formed by applying an aqueous dispersion of polyethylene particles and then drying it by heating. It is possible to produce resin coat paper also by application of a dispersion of polymer other than polyethylene.

The support may be provided with a back coat layer. Examples of components which may be added to the back coat layer include white pigments, aqueous binders, and other components.

Examples of the white pigments contained in the back coat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate, or magnesium hydroxide, and organic pigments such as styrene plastic pigments, acrylic plastic pigments, polyethylene, microcapsules, urea resins, or melamine resins.

Examples of the aqueous binder used for the back coat layer include water-soluble polymers such as styrene/maleate copolymer, styrene/acrylate copolymers, polyvinyl alcohol, silanol-modified polyvinyl alcohol, starch, cationic starch, casein, gelatin, carboxymethyl cellulose, hydroxyethyl cellulose, or polyvinylpyrrolidone, and water-dispersible polymers such as styrenebutadiene latex or acrylic emulsion.

Examples of other components to be contained in the back coat layer include antifoaming agents, foam suppressors, dyes, fluorescent whiteners, antiseptics, and waterproof agents.

Preparation of Image-Receiving Layer

The image-receiving material of the invention is prepared by applying a coating liquid for forming a porous layer onto a support such as that described above, thereby forming a porous layer on the support.

Particularly in the second embodiment, when at least one of the charged organic particles and the charged water-soluble polymer is weakly charged, it is desirable to apply, to a support, a coating liquid whose pH has been adjusted so that applicability and crosslinking coagulatability of the coating liquid are balanced (first method) or, alternatively, to adjust the pH of the coating liquid to a pH which is most suitable for applicability and then, at the same time when applying this coating liquid to a support or before drying the coat layer formed by the application, add a pH regulator to the coat layer to regulate the pH so that the coat layer has a pH suitable for crosslinking coagulation (second method).

Regarding the adjustment of pH of the coating liquid in the first method, it is desirable to determine an optimum pH range in consideration of the facts that particles (particulates) and the like are dispersed with stability in the coating liquid, that the viscosity of the coating liquid possesses application suitability, and that the formation of the porous layer through coagulation (crosslinking coagulation) of the particles (particulates) after the application is well occurred (when too much importance is placed on the dispersion stability or the applicability, good crosslinking coagulation may not occur; in contrast, when too much importance is placed on crosslinking coagulation, the dispersion stability or the applicability may decrease).

As the pH regulator of the coating liquid, alkali metal compound such as NaOH or KOH are used for increasing pH, and inorganic acid such as hydrochloric acid, sulfuric acid and phosphoric acid, or organic acid such as acetic acid is used for reducing pH.

Further, another desirable method is a method in which the pH of the coating liquid is adjusted to a pH suitable for the application of the liquid by use, for example, of a volatile pH regulator as the pH regulator of the coating liquid and after the application the pH regulator is vaporized from the resultant coat layer to change the pH and thereby the pH of the coat layer is adjusted to a pH suitable for crosslinking coagulation. The volatile pH regulator used herein means a pH regulator having a vapor pressure sufficient to vaporize in the drying step during the formation of a porous layer. Examples of the volatile pH regulator include ammonium water, aqueous amine solution, hydrochloric acid, and acetic acid.

For example, in a combination of weak cationic particles and either strong anionic particulates or strong anionic water-soluble polymer (e.g., a combination of —NH₂ group-containing particles and either —SO₃⁻ group-containing particulates or —SO₃⁻ group-containing water-soluble resin binder), when ammonia water is used as the pH regulator of a coating liquid, ammonia vaporizes from the coat layer resulting from application of the coating liquid and therefore the pH of the coat layer is reduced and crosslinking coagulation is promoted. During this process, the volatization may be promoted by heating and drying the coat layer. A method comprising increasing the pH by decarboxylating by heating or the like is also useful. For example, sodium hydrogencarbonate, which is weakly alkaline, decomposes at a temperature of 65° C. or higher into sodium carbonate, which is strongly alkaline.

As the pH regulator for use in the second method, not only a liquid pH regulator but also a gaseous pH regulator is usable.

The pH regulation of the coat layer using a liquid pH regulator is carried out by applying a liquid containing the pH regulator over a coat layer formed from a coating liquid for forming a porous layer, which method is called overlayer application, or by spraying mist of a liquid containing the pH regulator to the coat layer. The application or the spraying is carried out during the formation of the coat layer or before the coat layer formed by the coating is dried. As the liquid containing the pH regulator, the pH regulator used for the aforementioned coating liquid may also be used.

The pH regulation of the coat layer using a gaseous pH regulator is carried out by applying a gaseous pH regulator on the coat layer. As the pH regulator, ammonia gas, hydrogen chloride gas, carbon dioxide gas, etc may be used.

The coating liquid used in the second method is subjected to pH regulation so as to have a positive charge-to-negative charge ratio such that particles, particulates and the like are dispersed with stability in the coating liquid and the coating liquid has a viscosity suitable for its application. It is desirable to regulate the pH of the coat layer so that the pH changes to a pH at which crosslinking coagulation which forms a desirable porous structure is successfully formed in a short time, by adding a pH regulator to the coat layer after the application of the coating liquid to re-regulate the positive charge-to-negative charge ratio.

Further, in the second method, when a combination of charged particles and charged particulates, at least one of which is weakly charged, or a combination of charged particles and a charged water-soluble polymer, at least one of which is weakly charged, is used, the pH regulation of the coat layer is concretely carried out in the following manner.
1) In the case of a combination of weak anionic particles and either strong cationic particulates or strong cationic water-soluble polymer (e.g., a combination of —COOH group-containing particles and either quaternary ammonium salt group-containing particulates or water-soluble resin polymer), the pH regulation is carried out by adding an alkali pH regulator.
2) In the case of a combination of weak cationic particles and either strong anionic particulates or strong anionic water-soluble polymer (e.g., a combination of —NH₂ group-containing particles and either —SO₃⁻ group-containing particulates or water-soluble resin polymer), the pH regulation is carried out by adding an acidic pH regulator.
3) In the case of a combination of weak anionic particles and either weak cationic particulates or weak cationic water-soluble polymer (e.g., a combination of —COOH group-containing particles and either —NH₂ group-containing particulates or water-soluble resin polymer), the pH regulation is carried out using an acidic or alkaline pH regulator.
4) In the case of a combination of weak cationic particles and either weak anionic particulates or weak anionic water-soluble polymer (e.g., a combination of —NH₂ group-containing particles and either —COOH group-containing particulates or water-soluble resin polymer), the pH regulation is carried out using an acidic pH regulator.

The coating liquid for a porous layer is prepared by dispersing or dissolving the components to form the porous layer in water or a mixed solvent of water and a water-soluble solvent. When the aforementioned polymer dispersion is used as the particles having a charge, it may be used as received.

Examples of the water-soluble solvent include alcohols such as methanol, ethanol, n-propanol, i-propanol and methoxypropanol and acetone.

The coating liquid for a porous layer may applied by a conventional coating method using, for example, an extrusion die coater, an air doctor coater, a bread coater, a rod coater, a knife coater, a squeeze coater, a reverse roll coater or a bar coater.

When applying a pH regulator on a coat layer, it is desirable to use an extrusion die coater. For spraying a pH regulator on the coat layer, a conventional spraying method is usable.

Image-Forming Method

In the first embodiment of the invention, the image-forming method is characterized in that after printing on the aforementioned image-receiving material with an ink, a smoothening treatment is carried out. Highly glossy images are formed by the smoothening treatment.

Example of the smoothening method include a method comprising pressuring a printed surface, which is called “smoothening under pressure,” a method comprising heating a printed surface, which is called “smoothening under heat,” and a method comprising heating and pressuring a printed surface, which is called “smoothening under heat and pressure.” When smoothening is conducted with heating, the image-receiving material is cooled, if necessary, after the heating.

As a means for pressuring to be used in the smoothening under pressure, usable is a method including passing an image-receiving material after printing through a nip portion of a pressure roller consisting of a pair of rollers. As the pressure roller, metallic rollers made, for example, of stainless steel having a surface mirror-finished by hard chrome plating or the like are used. The pressuring condition is approximately from 16 to 30 kg/cm.

As a means for heating to be used in the smoothening under heating, usable is a method including heating an image-receiving material after printing from above the printed surface with radiant heat from, for example, an infrared lamp or a plane heater. The heating temperature of the surface of the image-receiving material may be selected according to the Tg of the porous layer, but it is generally from about 80 to about 160° C.

Further as the means for heating and pressuring in the smoothening under heat and pressure, usable are, for example, a method comprising passing an image-receiving material after printing through a nip portion of a pair of heating rollers, at least one of which is provided therein with a heating means, or a method comprising passing an image-receiving material after printing through a nip portion of a pressure roller and a heating belt.

As the aforementioned pair of heating rollers, usable are metallic rolls made of, for example, aluminum or stainless steel having on or above their surface a releasing layer made of silicone resin (rubber), fluororesin (rubber) or the like. Further, an elastic material layer may optionally be disposed under the releasing layer. As the heating means provided within the roller(s), conventional heating means such as a halogen lamp, an electrical heating and a dielectric heating are adaptable.

In the smoothening under heat and pressure using the pair of heating rollers, a heating temperature of the surface of the image-receiving material may be selected according to the Tg of the porous layer, but it is generally from about 80 to about 160° C. The pressuring condition is from about 1 to about 30 kg/cm.

The heating belt for use in the smoothening under heat and pressure has two or more rollers and a belt stretched between the rollers. A heating means is provided with inside of one of the rollers. A pressure roller is placed opposite the roller having a heating means therein to form a nip portion. The pressure roller also may have a heating means inside. As the heating means provided within the roller(s), conventional heating means such as a halogen lamp, an electrical heating and a dielectric heating are adaptable.

As the pair of opposite rollers, those in which a releasing layer made of silicone resin (rubber) or flororesin resin (rubber) is disposed on the surface of a roller of metal such as aluminum and stainless steel are usable. In view of heat resistance and mechanical strength, usable is a belt in which a releasing layer containing rubber superior in heat resistance and releasing property, such as silicone rubber, fluorine rubber, silicon-fluorine rubber, is formed on a sheet of metal such as nickel, aluminum and stainless steel or a film of resin such as PET, PBT, polyester, polyimide, or polyimideamide.

In the case of the smoothening under pressure using a heating belt and a pressure roller, the heating temperature of the surface of the image-receiving material may be selected according to the Tg of the porous layer, but it is generally from about 80 to about 160° C. The pressuring condition is from about 1 to about 30 kg/cm.

When releasing the heating belt from the surface of the image-receiving material after heating, it is desirable to cool the heating belt before the release because the smoothness of the release surface is improved.

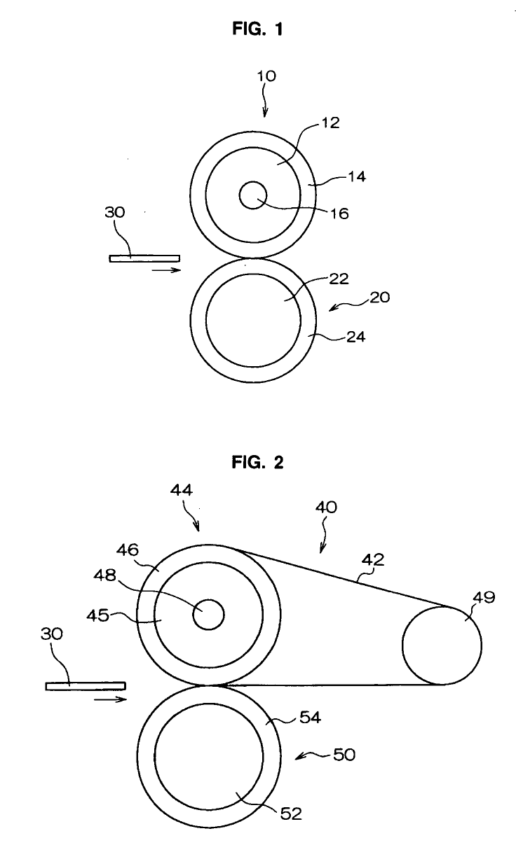

FIG. 1 illustrates one example of the heating roller used for smoothening under heat and pressure. In FIG. 1, reference numerals 10 and 20 each indicates a roller, 12 and 22 each indicates a metal roller, and 14 and 24 each indicates a releasing layer. Inside roller 10, heating means 16, such as a halogen lamp, is provided. The reference numeral 30 denotes a printed image-receiving material. The printed surface is smoothened when the image-receiving material passes through a nip portion of the pair of roller.

FIG. 2 illustrates another means for use in smoothening under heat and pressure. Reference numeral 40 indicates a heating belt. Reference numeral 42 indicates a belt, 44 indicates a heating roller, 45 indicates a metal roller, 46 indicates a releasing layer, 48 indicates a heating means such as a halogen lamp, and 49 indicates a supporting roller. Reference numeral 50 indicates a pressure roller that forms a nip portion together with heating roller 44. Reference numerals 52 indicates a metal roller, and 54 indicates a releasing layer.

Ink

Regarding ink for printing on the image-receiving material of the invention, although any ink such as water-soluble dye ink, pigment ink, dispersion ink, UV ink, and Solvent ink may be used without any limitations, the effect of the invention is particularly shown when a dispersion ink is used. When the image-receiving material is used for ink jet printing, an ink for ink jet printing such as those shown below are used.

Dispersion Ink

The dispersion ink is an ink in which colored particles enclosing an oil-soluble dye are dispersed in oil-soluble polymer particles. The ink is obtained by preparing an oil phase (organic phase) by mixing at least one oil-soluble dye, at least one oil-soluble polymer, and at least one organic solvent having a low-boiling point and a water solubility of 4 g or less, adding the resulting oil phase to water (aqueous phase), and emulsifying the mixture with a homogenizer.

By adding a water-soluble compound having a hydrophobic group at a terminal of a molecule thereof (including a polymer) to the dispersion of the colored particles, it is possible to effectively inhibit a coagulation of the colored particles (dispersed drops) to maintain a homogeneous dispersion state with stability.

The above-described dispersion ink is disclosed in detail in the specification of Japan Patent Application No. 2003-24530. The dispersion ink disclosed in the specification can be used for the recording method of the invention.

The aforementioned oil-soluble dye means a dye substantially insoluble in water, and specifically means a dye having a water solubility, which is the mass of dye which can dissolve in 100 g of water, is 1 g or less at 25° C. The range of the solubility is preferably up to 0.5 g and more preferably up to 0.1 g. The oil-soluble dye preferably has a melting point up to 200° C., more preferably up to 150° C., and particularly preferably up to 100° C. If the melting point of the oil-soluble dye is low, the formation of precipitants of crystals of the dye is inhibited, resulting in an improvement in dispersion stability of ink and in a storage stability of ink.

Examples of the oil-soluble dye include anthraquinone dyes, naphthoquinone dyes, styryl dyes, indoaniline dyes, azo dyes, nitro dyes, coumarin dyes, methine dyes, porphyrin dyes, azaporphyrin dyes, and phthalocyanine dyes. It should be noted that full-color printing generally requires at least four colors including black (K) in addition to the three primary colors, i.e. yellow (Y), magenta (M) and cyane (C). Regarding specific examples of dyes of these four colors and the contents of the dyes in ink, those disclosed in paragraphs 0030-0213 of the above-mentioned specification can be applied.

The aforementioned oil-soluble polymer is polyester or an addition polymer. Regarding specific examples of the polymer and the amount of the polymer added to the oil-soluble dye, the descriptions of paragraphs 0217-0239 of the above-mentioned specification can be applied.

The organic solvent having a low-boiling point is added as a solvent for dissolving the oil-soluble polymer and the oil-soluble dye, and is added in order to reduce the dispersion particle diameter of the emulsified dispersion. It is preferable to remove the organic solvent having a low-boiling point after emulsification by heating under reduced pressure, ultrafiltration, etc. The solubility of the organic solvent having a low-boiling point in water at 25° C. is up to 4 g, preferably up to 3 g, more preferably up to 2 g, and particularly preferably up to 1 g. The boiling point is up to 100° C., preferably up to 80° C. and particularly preferably up to 70° C. Specific examples thereof include those disclosed in paragraphs 0295-0296 of the above-mentioned specification.

In order to control the glass transition temperature of the oil-soluble polymer or to improve the dispersion stability, a organic solvent having a high-boiling point may also be added.

The organic solvent having a high-boiling point is an organic solvent having a boiling point of 200° C. or higher and a melting point of 80° C. or lower. Especially, one having a water solubility at 25° C. of 4 g or less is preferred. If the water solubility (at 25° C.) is over 4 g, particles constituting an ink composition get liable to increase in particle size or coagulate with time and, therefore, a significant bad effect may be exerted on a property of ink ejection. The water solubility is preferably up to 4 g, more preferably up to 3 g, still more preferably up to 2 g, and particularly preferably up to 1 g. Regarding specific examples of the organic solvent having a high-boiling point and the addition amount thereof, those disclosed in paragraphs 0260-0293 of the above-mentioned specification can be applied.

The aforementioned water-soluble polymer having a hydrophobic group at a terminal of a molecule thereof is a polymer in which a hydrophobic group or a hydrophobic polymer is linked to a water-soluble polymer via a divalent linking group having a hetero bond.

The hydrophobic group refers, for example, to aliphatic groups, aromatic groups and alicyclic groups. Specific examples thereof include those disclosed in paragraphs 0306-0314 of the above-mentioned specification. The hydrophobic polymer refers to polystyrene and modified compounds of polystyrene, polymethacrylic acid esters and modified compounds of polymethacrylic acid ester, polyacrylic acid esters and modified compounds of polyacrylic acid esters, polyvinyl chloride, etc. The divalent linking group having a hetero bond refers to an ether bond, an ester bond, a thioether bond, a thioester bond, etc. Examples of the water-soluble polymer include polymers obtained by polymerizing monomers containing a vinyl alcohol monomer, at least one of monomer selected from an unsaturated carboxylic acid monomer, an unsaturated sulfonic acid monomer and an unsaturated phosphonic acid monomer, and a vinyl ester monomer (including vinyl acetate, vinyl formate and vinyl propionate); and a polymer containing —CH₂—C(R)(OH)—H₂—O— (wherein R is a hydrogen atom or an alkyl group having 1 to 10 carbon atoms) as a repeating unit.

Regarding specific examples of the water-soluble polymer having a hydrophobic group at a terminal of a molecule thereof and the content thereof in ink, those disclosed in paragraphs 0329-0332 can be applied.

In addition to the aforementioned components, other water-soluble polymers disclosed in paragraph 0336 of the above-mentioned specification and surfactants disclosed in paragraph 0337 of the above-mentioned specification may optionally be employed.

The average particle diameter of the dispersion ink is preferably from 0.01 to 0.1 μm.

Pigment Ink

Pigment ink is prepared by adding a water-insoluble organic pigment to an aqueous medium containing a surfactant, a dispersed polymer and the like and then pulverizing the pigment with hard beads by a disperser such as a sand mill, a ball mill or the like. In the pigment ink, it is possible to homogeneously disperse the pigment with stability in the aqueous medium without causing coagulation of the pigment by making a water-soluble polymer having a hydrophobic group at a terminal of a molecule thereof, which was mentioned in the description on the dispersion ink, coexist with the pigment. Such a pigment ink is disclosed in detail in the specification of Japan Patent Application No. 2003-24004 and is used for the recording method of the invention. Regarding the sort of the water-soluble polymer having a hydrophobic group at a terminal of a molecule thereof and the content thereof in ink, those disclosed in paragraphs 0023-0056 of the above-mentioned specification can be applied. Regarding the kind of the usable pigment and the content thereof in ink, those disclosed in paragraphs 0057-0058 can be applied.

Water-Soluble Dye Ink

Water-soluble dye ink is an ink obtained by dissolving a water-soluble dye in an aqueous medium. The water-soluble dye ink is characterized by its high transparency and high color density. The water-soluble dye exhibits good stability in water. However, it rarely forms crystals gradually. The occurrence of this phenomenon in a nozzle will cause clogging. Therefore, if a water-soluble polymer similar to that described above in which a polymer containing —CH₂—C(R)(OH)—CH₂—O— as a repeating unit and either a hydrophobic group or a hydrophobic polymer, wherein R is a hydrogen atom or an alkyl group having 1 to 6 carbon atoms, are linked via a divalent linking group having a hetero bond is added to a water-soluble dye ink, the formation of precipitants of crystals of the dye during storage is inhibited. Accordingly, the occurrence of clogging in a nozzle is prevented and even if clogging occurs, a good cleaning property is achieved at that portion. Such a water-soluble ink is disclosed in detail in the specification of Japan Patent Application No. 2003-100492. Regarding usable water-soluble dyes and the content of a water-soluble dye in ink, those disclosed in paragraphs 0045-0056 of the specification can be applied. Regarding the hydrophobic group-containing water-soluble polymer and the content of the polymer in ink, those disclosed in paragraphs 0019-0043 of the specification can be applied.

Photo-Curable Ink

The photo-curable ink is an ink which is cured through polymerization caused by application of light (UV, etc.) after printing. It contains at least a colorant, a photopolymerization initiator, and at least one of a photo-curable oligomer and a monomer. The photo-curable ink includes both aqueous one and nonaqueous one, and any of which is usable. As the aqueous photo-curable ink, usable are those disclosed in paragraphs 0035-0053 and 0056-0065 of JP-A No. 2001-323194 [photo-curable monomers/oligomers (0035-0037), photopolymerization initiators (0038-0040), colorants (0041-0048), aqueous medium (0051-0052)] and those disclosed in paragraphs 0015-0078 and 0089-0093 of JP-A No. 2000-336295 [photopolymerizable urethane oligomers/monomers (0016-0028), photopolymerization initiators (0030-0032), colorants (0030-0038), aqueous solvents (0043-0044)]. Further, as the nonaqueous photo-curable ink, usable are those disclosed in paragraphs 0005-0048 of JP-A No. 2003-147233 [pigments (0013), UV-Curable compounds (0014-0019), photopolymerization initiators and sensitizers (0020-0023)].

Another example of the photo-curable ink is one in which a photopolymerizable monomer is used instead of the oil-soluble polymer together with a photopolymerization initiator in the dispersion ink. Regarding specific examples of the photopolymerizable monomer and the addition amount thereof to the oil-soluble dye, those disclosed in paragraphs 0242-0248 of the above-mentioned JP Patent Application No. 2003-24530 can be applied. Regarding the sort of the photopolymerization initiator and the addition amount thereof, those disclosed in paragraphs 0249-0255 of the specification of the above-mentioned Japan Patent Application No. 2003-24530 can be applied.

By polymerizing and curing the photopolymerizable monomers after printing by light such as ultraviolet rays, the printed images are fixed to an arbitrarily selected recording material and thereby the image stability, namely, the water resistance and the light resistance (especially, ozone resistance), and the chafing resistance of images are improved.

Solvent Ink

The solvent ink is an ink prepared by dissolving an oil-soluble dye in an organic solvent. As the oil-soluble dye, the oil-soluble dyes disclosed in the section on the dispersion ink may be used. As the organic solvent, usable are those disclosed from line 5 from the bottom on the lower-right column in page 4 to line 5 on the lower-right column in page 5 of Japan Patent Application Laid-open No. 63-60784 and from line 2 on the upper-left column to line 7 on the lower-left column in page 5 of the same publication.

The specific examples of the preferable embodiments of the present invention will be described in more detail below, but the invention is not limited to the examples.

<1> An image-receiving material comprising a support and a porous layer disposed on or above the support, wherein the image-receiving material satisfies at least one of requirements (1) and (2) defined below, and the porous layer comprises particles having a charge and either particulates having a charge opposite to that of the particles or a water-soluble polymer having a charge opposite to that of the particles: (1) the porous layer is the uppermost layer having an average pore diameter of from 0.05 to 100 μm; (2) the particles are organic particles.

<2> The image-receiving material of the above <1>, wherein the image-receiving material satisfies the requirement (1) and after having been printed with ink and smoothened, the printed surface of the image-receiving material has a glossiness of 30% or more at a 75° C. incident angle of specular reflection.

<3> The image-receiving material of the above <1>, wherein the image-receiving material satisfies the requirement (2) and the porous layer is formed by applying a coating liquid containing the particles and either the particulates which are organic particulates or the water-soluble polymer having a charge opposite to that of the particles.

<4> The image-receiving material of the above <2>, wherein the porous layer has an average pore diameter of from 0.001 to 100 μm.

<5> The image-receiving material of the above <3>, wherein the porous layer is thermoplastic.

<6> The image-receiving material of the above <3>, wherein the porous layer contains the organic particulates and at least one of the organic particles and the organic particulates is weakly charged.

<7> The image-receiving material of the above <3>, wherein the porous layer contains the water-soluble polymer, and at least one of the organic particles and the water-soluble polymer are weakly charged.

<8> The image-receiving material of the above <3>, wherein each of the organic particles has an anionic group or a cationic group.

<9> The image-receiving material of the above <3>, wherein the porous layer contains the water-soluble polymer, and the water-soluble polymer has an anionic group or a cationic group.

<10> The image-receiving material of the above <3>, wherein the image-receiving material is for ink jet printing.

<11> A method for producing an image-receiving material comprising applying a coating liquid on or above a support to form a porous layer, wherein the coating liquid comprises organic particles having a charge and either organic particulates having a charge opposite to that of the organic particles or a water-soluble polymer having a charge opposite to that of the organic particles.

<12> The method of the above <11>, wherein the coating liquid has a viscosity within a range from 10 to 500 mPa·s and the coating liquid contains no sediment.

<13> The method of the above <11>, wherein the method comprises regulating the viscosity of the coating liquid through a pH regulation of the coating liquid.

<14> The method of the above <11>, wherein the pH regulation of the coating liquid is carried out using a pH regulator.

<15> The method of the above <11>, wherein the pH regulator is volatile.

<16> The method of the above <11>, wherein a pH regulator is added to the coat layer during application of the coating liquid or before the coat layer formed by the application is dried.

<17> An image-forming method comprising printing with ink on an image-receiving material having a support and a porous layer disposed on or above the support, wherein the method satisfies at least one of requirements (1) and (2) defined below, and the porous layer contains particles having a charge and either particulates having a charge opposite to that of the particles or a water-soluble polymer having a charge opposite to that of the particles: (1) the porous layer is the uppermost layer having an average pore diameter of from 0.05 to 100 μm; (2) the particles are organic particles.

<18> The image-forming method of the above <17>, wherein the method satisfies the requirement (1) and a smoothening treatment is applied to a print surface formed on the image-receiving material through the printing with ink.

<19> The image-forming method of the above <18>, wherein the porous layer is thermoplastic.

<20> The image-forming method of the above <18>, wherein the smoothening is smoothening under pressure, smoothening under heat, or smoothening under heat and pressure.

<21> The image-forming method of the above <18>, wherein the smoothening treatment comprises of passing the printed image-receiving material between a pair of heating rollers.

<22> The image-forming method of of the above <18>, wherein the smoothening treatment comprises passing the printed image-receiving material between a heating belt and a pressure roller.

<23> The image-forming method of the above <18>, wherein the method satisfies the requirement (2), the porous layer contains the particulates, and the particulates are organic particulates.

<24> The image-forming method of the above <18>, wherein the particles having a charge have a glass transition temperature of 25° C. or higher.

<25> The image-forming method of the above <18>, wherein the ink is a dispersion ink in which colored particles enclosing an oil-soluble dye are dispersed in oil-soluble polymer particles.

<26> The image-forming method of the above <18>, wherein the image-receiving material is an image-receiving material for ink jet printing and the ink is for ink jet printing.

<27> The image-forming method of the above <17>, wherein the requirement (2) is satisfied and the ink is a dispersion ink in which colored particles enclosing an oil-soluble dye are dispersed in oil-soluble polymer particles.

<27> The image-forming method of the above <17>, wherein the, image-receiving material satisfies the requirement (1) and after having been printed with ink and smoothened, the printed surface of the image-receiving material has a glossiness of 30% or more at a 75° C. incident angle of specular reflection.

### EXAMPLES

The image-forming method of the present invention will be described in more detail below, but the invention is not limited to the examples. Hereinafter, all designations of “parts” and “%” indicate “parts by mass” and “mass %,” respectively.

### Example 1

Preparation of Image-Receiving Material for Ink Jet Printing

Preparation of Support

Wood pulp formed of 100 parts of LBKP was broken up with a double-disc refiner until the Canadian freeness of 300 ml. 0.5 parts of epoxidized behenic acid amide, 1.0 part of anion polyacrylamide, 0.1 part of polyamide polyamine epichlorohydrine, and 0.5 parts of cation polyacrylamide were added to the pulp in an absolute dry mass ratio with respect to the pulp to make base paper having a weight of 170 g/m², using a Fourdrinier paper machine.

In order to adjust the surface size of the base paper, 0.04% of an fluorescent whitener (trade name: WHITEX BB, manufactured by Sumitomo Chemical Co., Ltd.) was added to a 4% aqueous solution of polyvinyl alcohol, and the base paper was impregnated with the resulting mixture and dried so that the absolute dry mass of the mixture was 0.5 g/m². Thereafter, the base paper was subjected to calender treatment to obtain base paper whose density had been adjusted to 1.05 g/cm³.

After a wire surface (back surface) of the obtained base paper had been subjected to corona discharge treatment, high-density polyethylene was coated onto the wire surface using a melt extrusion machine to form a matted resin layer having a thickness of 19 μm. (Hereinafter, this resin layer surface is referred to as the “back surface”.) After a corona discharge treatment had been carried out on the resin layer of the back surface, a dispersion, in which aluminum oxide (trade name: ALUMINASOL 100, manufactured by Nissan Chemical Industries, Ltd.) and silicon dioxide (SNOWTEX® O, manufactured by Nissan Chemical Industries, Ltd.) were dispersed in water at a mass ratio of 1:2, was applied as an antistatic agent onto the resin layer so that the dry mass thereof was 0.2 g/m².

Further, after a resin layer-free felt surface (front surface) of the base paper had been subjected to corona discharge treatment, low-density polyethylene, which included 10% of titanium dioxide having an anatase structure, a trace amount of an ultramarine blue pigment, and 0.01% (based on polyethylene) of a fluorescent whitener and had an MFR (i.e., melt flow rate) of 3.8, was coated onto the felt surface using a melt extrusion machine to form a highly glossy thermoplastic resin layer having a thickness of 29 μm. (Hereinafter, this surface is referred to as a “surface”.) The sheet thus obtained was used as a support.

Formation of Porous Layer

While 100 parts of a 35% aqueous dispersion (pH 4) of anionic particles A-1 having a structural formula show below was stirred, 10 parts of a 35% aqueous dispersion (pH 6.8) of cationic particles K-1 having the structural formula shown below was added. The pH was adjusted to 7.8 with NaOH (1N). Thus, a desired coating liquid for a porous layer was prepared. The coating liquid had a viscosity of 115 mP·s.

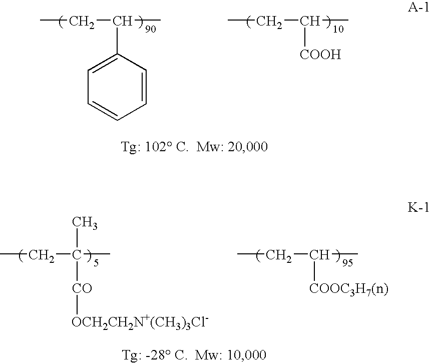

After the surface of the support had been subjected to a corona discharge treatment, the coating liquid for the above-mentioned porous layer was applied to the surface of the support in an application amount of 85 ml/m² using an extrusion die coater (coating process) and dried at 80° C. with a hot air dryer (at a wind speed of from 3 to 8 n/sec) for 10 minutes (drying process).

An image-receiving material A for ink jet printing with a porous layer having a dry film thickness of about 30 μm was thus obtained.

Image Formation

Preparation of Dispersion Ink

To 10 parts of ethyl acetate, 0.6 parts of oil-soluble dye (a) shown below, 1.4 parts of an oil-soluble polymer (butyl acrylate/methyl methacrylate copolymer [copolymerization ratio (molar ratio)=50/50]) and 0.3 parts of compound (B-1) shown below were mixed to yield solution I (organic phase). Separately, 0.3 parts of sodium di(2-ethylhexyl)sulfosuccinate was added to 15 parts of water to yield solution II (aqueous phase).

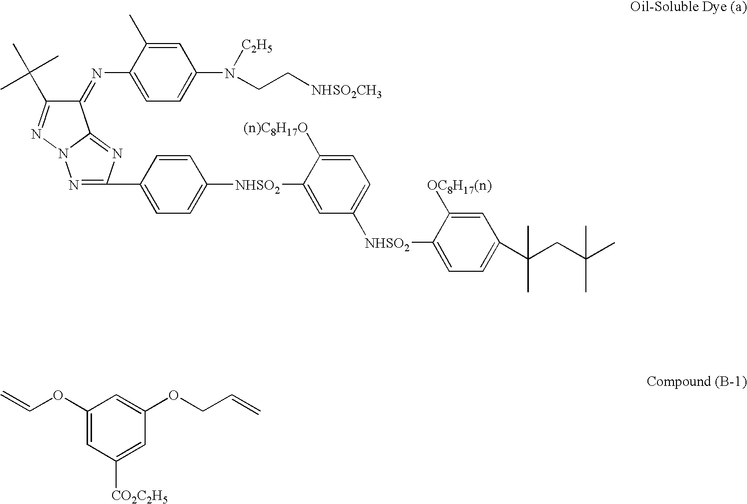

Solution I was added to solution II and emulsion-dispersed using a homogenizer. Then, 5 parts of a 10% solution of water-soluble polymer (C-1) shown below was added and stirred. Thereafter, ethyl acetate was removed under reduced pressure to yield colored particle dispersion D-1 having a solid content of 10%. The particle diameter of the dispersed drops (organic phase) in the colored particle dispersion D-1 was measured using a particle size distribution analizer (trade name: LB-500, manufactured by Horiba Ltd.) to find a volume-average particle diameter of 85 nm.

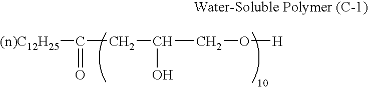

Using the colored particle dispersion D-1 obtained, the following components were mixed and filtered through a filter having a mesh of 0.45 μm to obtain ink for ink jet printing according to the invention.

| | |
|---|---|
| Colored particle dispersion (D-1) | 60 parts |
| Diethylene glycol | 5 parts |
| Glycerine | 15 parts |
| Diethanolamine | 1 part |
| Polyethylene glycol | 1 part |
| Water | fill up to 100 parts in total |

Measurement of Average Pore Diameter of Porous Layer

The average pore diameter was measured with the method described in the later section of paragraph 0018 using a scanning electron microscope. The result is shown in Table 1.

Evaluation of Ink Permeability in Porous Layer

The ink permeability was determined using an automatic scanning absorptometer (trade name: KM500WIN, manufactured by Kumagai Rikogyoki Co. Ltd.) using a modified Bristow method. The method for measurement using this device is disclosed in “Japan TAPPI Journal”, Vol. 48, No. 6, pp. 88-92. Using this device, the transfer amount of the dispersion ink to a porous layer was measured. The slope of an absorption curve (liquid transfer amount vs. contact time) produced based on the measurement was determined. Time (t30 (sec)) necessary for 30 ml/m² of the dispersion ink to permeate was then calculated and ink permeability was evaluated. The result is shown in Table 1.

Image Formation

An ink jet printer cartridge was filled with black dispersion ink (trade name: PM950, manufactured by Seiko Epson Corp.) and solid printing was performed on the image-receiving material for ink jet printing.

Then, a 100 μm thick polyimide film coated with silicone resin having releasability was prepared and the surface of this film coated with the releasing agent was superposed on the printed surface of the image-receiving material. The supperposed matter was passed through a pair of heating rollers, and subjected to smoothening treatment under heat and pressure. During this process, the temperature of the rollers was controlled so that the temperature of the printed surface became 140° C. The nip pressure was set to 20 Kg/cm. After cooling, the polyimide film was removed from the image-receiving material for ink jet printing.

Evaluation of Glossiness of Printed Surface

For the printed image-receiving material for ink jet printing, the glossiness of the printed surface was measured and evaluated before and after the smoothening treatment according to a conventional method (testing method for 75° specular gloss paper). The results are shown in Table 1.

Evaluation of Image Density

The density of the solid printed portion of the image-receiving material for ink jet printing was measured before and after the smoothening treatment using a Macbeth densitometer.

The results are shown in Table 1.

### Example 2

An image-receiving material B was prepared in the same manner as Example 1 except that the preparation of the coating liquid for the porous layer was changed as shown below. Then, evaluation of the porous layer and image formation were carried out in the same manner.

Preparation of Coating Liquid for Porous Layer

20 parts of deionized water was added to 100 parts of a 50% dispersion of anionic particle A-2 (trade name: ES-90, manufactured by Chuo Rika Industries, Ltd., dispersion of carboxyl group-containing acrylic copolymer (Tg: 108° C.), pH: 8). While the mixture was stirred, 10 parts of a 40% dispersion of cationic particles K-2 (trade name: VINIBLON 2642, manufactured by Nissin Kagaku Industry Co., Ltd., dispersion of acrylic copolymer containing monomer units containing quaternary ammonium salt (Tg: −34° C.), pH: 6) was added and the pH was adjusted to 8.0 with NaOH (1N). Thus, a desired coating liquid for forming a porous layer was prepared.

The coating liquid had a viscosity of 210 mP·s.

### Example 3

An image-receiving material C was prepared in the same manner as Example 1 except that the preparation of the coating liquid for a porous layer was chainged as shown below. Then, evaluation of the porous layer and image formation were carried out in the same manner.

Preparation of Coating Liquid for Porous Layer

While 100 parts of a 35% aqueous dispersion (pH: 11) of cationic particles K-3 represented by the structural formula shown below was stirred, 10 parts of a 35% aqueous dispersion (pH: 7) of anionic particles A-3 represented by the structural formula shown below was added and the pH was adjusted to 7.3 with hydrochloric acid (1N). Thus, a desired coating liquid for forming a porous layer was prepared. The coating liquid had a viscosity of 240 mP·s.

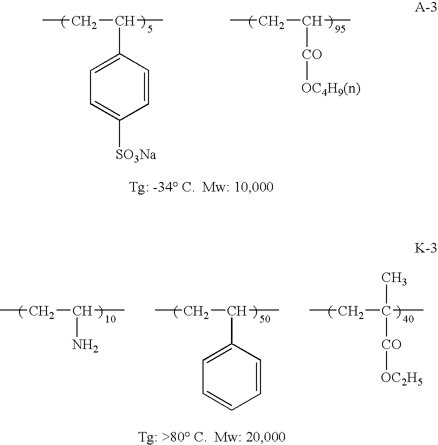

### Example 4

An image-receiving material D was prepared in the same manner as Example 1 except that the preparation of the coating liquid for a porous layer and the image-receiving material for ink jet printing were changed as shown below. Then, evaluation of the porous layer and image formation were carried out in the same manner.

Preparation of Coating Liquid for Porous Layer

While 100 parts of a 35% aqueous dispersion (pH: 11) of cationic particles K-3 represented by the structural formula shown above was stirred, 10 parts of a 35% aqueous dispersion (pH: 7) of anionic particles A-3 represented by the structural formula shown above was added and the pH was adjusted to 9 with hydrochloric acid (1N). Thus, a desired coating liquid for forming a porous layer was prepared. The coating liquid had a viscosity of 10 mP·s.

Preparation of Overcoating Liquid for pH Regulation

A 0.2% aqueous solution of acetic acid was prepared from acetic acid and deionized water. Then, an overcoating liquid for pH regulation was prepared by adding 0.1 parts of acetylene diol/nonionic surfactant (trade name: OLFINE PD-101, manufactured by Nissin Kagaku Industry Co., Ltd.) to 100 parts of the aqueous acetic acid solution in order to regulate the surface tension.

Preparation of Image-Receiving Material for Ink Jet Printing

After the surface of a support which was the same as that used in Example 1-1 had been subjected to corona discharge treatment, the coating liquid for a porous layer and the overcoating liquid for pH regulation were applied to the surface of the support in an application amount of 85 ml/m² and 8 ml/m², respectively, using an extrusion die coater (coating process) and dried at 80° C. with a hot air dryer (at a wind speed from 3 to 8 m/sec) for 10 minutes (drying process). An image-receiving material D for ink jet printing with a porous layer having a dry film thickness of about 30 μm was thus obtained.

### Example 5

An image-receiving material E was prepared in the same manner as Example 4 except that when hot air drying was carried out instead of applying the overcoating liquid for pH regulation, the drying was carried out using air containing 20% carbon dioxide gas instead of using plain air. Then, evaluation of the porous layer and image formation were carried out in the same manner.

### Comparative Example 1

An image-receiving material F was prepared in the same manner as Example 1 except that the coating liquid was changed to that shown below. Then, evaluation of the porous layer and image formation were carried out in the same manner.

Preparation of Coating Liquid

While 100 parts of a 35% aqueous dispersion (pH: 4) of anionic particles A-1 represented by the structural formula shown previously was stirred, 10 parts of a 35% aqueous dispersion (pH: 7) of anionic particles A-3 described previously was added and the pH was adjusted to 7.8 with NaOH (1N). Thus, a desired coating liquid was prepared. The coating liquid had a viscosity of 74 mP·s.

### Comparative Example 2

An image-receiving material G was prepared in the same manner as Example 1 except that the coating liquid was changed to that shown below. Then, evaluation of the porous layer and image formation were carried out in the same manner.

Preparation of Coating Liquid

While 100 parts of a 35% aqueous dispersion (pH: 11) of cationic particles K-3 represented by the structural formula shown previously was stirred, 10 parts of a 40% aqueous dispersion (pH: 6) of cationic particles K-2 described previously was added and the pH was adjusted to 7.8 with NaOH (1N). Thus, a desired coating liquid was prepared. The coating liquid had a viscosity of 68 mP·s.

### Comparative Example 3

The preparation of a coating liquid was carried out in the same manner as Example 3 except that cationic particles K-1 were used instead of K-3 and that no pH regulation was carried out. However, it was not possible to apply the coating liquid due to the occurrence of heavy coagulation.

### Comparative Example 4

An image-receiving material H was prepared in the same manner as Example 3 except that pH regulation was not performed during the preparation of the coating liquid. Then, evaluation of the porous layer and image formation were carried out in the same manner as Example 3. The coating liquid had a pH of 10 and a viscosity of 53 mP·s.

TABLE 1

| | Average | | Before | | After | |
|---|---|---|---|---|---|---|
| | pore | Permeability | smoothening | | smoothening | |
| | diameter of | of dispersion | Glossiness | | Glossiness | |
| | porous layer | ink in porous | (75° | Image | (75° | Image |
| | (μm) | layer t(sec) | incidence) | density | incidence) | density |
| Example 1 | 1.2 | 0.1 | 2.3 | 1.25 | 78.6 | 1.59 |
| Example 2 | 1.0 | 0.2 | 3.1 | 1.32 | 80.3 | 1.63 |
| Example 3 | 1.5 | 0.3 | 1.6 | 1.19 | 75.9 | 1.55 |
| Example 4 | 1.1 | 0.2 | 2.8 | 1.26 | 81.2 | 1.57 |
| Example 5 | 0.9 | 0.5 | 4.5 | 1.37 | 83.0 | 1.66 |
| Comparative | Unable to | 15 | | | | |
| Example 1 | observe (≈0) | | | | | |
| Comparative | Unable to | 32 | | | | |
| Example 2 | observe (≈0) | | | | | |
| Comparative | Unable to | 25 | | | | |
| Example 3 | observe (≈0) | | | | | |

As shown by Table 1, by performing smoothing treatment after printing, the glossiness was increased remarkably and the image density was also improved in comparison to before the smoothening treatment.

By using the coating liquid having two kinds of organic grains having opposite charges, it is possible to form a porous layer having an average pore diameter within the range from 0.001 to 100 μm. In addition, the permeability of dispersion ink in this porous layer is high. This indicates that even when printing with a dispersion ink on an image-receiving material for ink jet printing having a porous layer according to the invention, it is possible to print images with a line head at high speed.

In contrast, when using grains having same charges (Comparative Examples 1, 2 and 4), it is impossible to obtain any substantial porosity and permeability of dispersion ink is therefore low. This means there is no possibility of printing images with a line head at high speed.

1. An image-receiving material comprising a support and a porous layer disposed on or above the support,
wherein the image-receiving material satisfies at least one of requirements (1) and (2) defined below, and
the porous layer comprises
particles having a charge and
either particulates having a charge opposite to that of the particles or a water-soluble polymer having a charge opposite to that of the particles:
(1) the porous layer is the uppermost layer having an average pore diameter of from 0.05 to 100 μm;
(2) the particles are organic particles.

2. The image-receiving material of claim 1, wherein the image-receiving material satisfies the requirement (1) and after having been printed with ink and smoothened, the printed surface of the image-receiving material has a glossiness of 30% or more at a 75° C. incident angle of specular reflection.

3. The image-receiving material of claim 1, wherein the image-receiving material satisfies the requirement (2) and the porous layer is formed by applying a coating liquid containing the particles and either the particulates which are organic particulates or the water-soluble polymer having a charge opposite to that of the particles.

4. The image-receiving material of claim 2, wherein the porous layer has an average pore diameter of from 0.001 to 100 μm.

5. The image-receiving material of claim 3, wherein the porous layer is thermoplastic.

6. The image-receiving material of claim 3, wherein the porous layer contains the organic particulates and at least one of the organic particles and the organic particulates is weakly charged.

7. The image-receiving material of claim 3, wherein the porous layer contains the water-soluble polymer, and at least one of the organic particles and the water-soluble polymer are weakly charged.

8. The image-receiving material of claim 3, wherein each of the organic particles has an anionic group or a cationic group.

9. The image-receiving material of claim 3, wherein the porous layer contains the water-soluble polymer, and the water-soluble polymer has an anionic group or a cationic group.

10. The image-receiving material of claim 3, wherein the image-receiving material is for ink jet printing.

11. A method for producing an image-receiving material comprising applying a coating liquid on or above a support to form a porous layer,
wherein the coating liquid comprises organic particles having a charge and
either organic particulates having a charge opposite to that of the organic particles or a water-soluble polymer having a charge opposite to that of the organic particles.

12. The method of claim 11, wherein the coating liquid has a viscosity within a range from 10 to 500 mPa·s and the coating liquid contains no sediment.

13. The method of claim 11, wherein the method comprises regulating the viscosity of the coating liquid through a pH regulation of the coating liquid.

14. The method of claim 13, wherein the pH regulation of the coating liquid is carried out using a pH regulator.

15. The method of claim 14, wherein the pH regulator is volatile.

16. The method of claim 11, wherein a pH regulator is added to the coat layer during application of the coating liquid or before the coat layer formed by the application is dried.

17. An image-forming method comprising printing with ink on an image-receiving material having a support and a porous layer disposed on or above the support,
wherein the method satisfies at least one of requirements (1) and (2) defined below, and
the porous layer contains
particles having a charge and
either particulates having a charge opposite to that of the particles or a water-soluble polymer having a charge opposite to that of the particles:
(1) the porous layer is the uppermost layer having an average pore diameter of from 0.05 to 100 μm;
(2) the particles are organic particles.

18. The image-forming method of claim 17, wherein the method satisfies the requirement (1) and a smoothening treatment is applied to a print surface formed on the image-receiving material through the printing with ink.

19. The image-forming method of claim 18, wherein the porous layer is thermoplastic.

20. The image-forming method of claim 18, wherein the smoothening is smoothening under pressure, smoothening under heat, or smoothening under heat and pressure.

21. The image-forming method of claim 18, wherein the smoothening treatment comprises of passing the printed image-receiving material between a pair of heating rollers.

22. The image-forming method of claim 18, wherein the smoothening treatment comprises passing the printed image-receiving material between a heating belt and a pressure roller.

23. The image-forming method of claim 18, wherein the method satisfies the requirement (2), the porous layer contains the particulates, and the particulates are organic particulates.

24. The image-forming method of claim 18, wherein the particles having a charge have a glass transition temperature of 25° C. or higher.

25. The image-forming method of claim 18, wherein the ink is a dispersion ink in which colored particles enclosing an oil-soluble dye are dispersed in oil-soluble polymer particles.

26. The image-forming method of claim 18, wherein the image-receiving material is an image-receiving material for ink jet printing and the ink is for ink jet printing.

27. The image-forming method of claim 17, wherein the requirement (2) is satisfied and the ink is a dispersion ink in which colored particles enclosing an oil-soluble dye are dispersed in oil-soluble polymer particles.

28. The image-forming method of claim 17, wherein the, image-receiving material satisfies the requirement (1) and after having been printed with ink and smoothened, the printed surface of the image-receiving material has a glossiness of 30% or more at a 75° C. incident angle of specular reflection.
